SEQUENCE LISTING (4 sequences)

SEQ ID NO: 1 - protein, 162 aa, Galdieria sulphuraria
MKTPITEAIAAADNQGRFLSNTELQAVNGRYQRAAASLEAARSLTSNAQRLINGAAQAVYSKFPYTSQMPGPQYASSAVGKAKCARDIGYYLRMVTYCLVVGGTGPMDEYLIAGLEEINRTFDLSPSWYVEALNYVKSNHGLSGQAANEANTYIDYAINALS

SEQ ID NO: 2 - protein, 172 aa, Galdieria sulphuraria
MLDAFAKVVAQADARGEFLSNTQLDALSKMVSEGNKRLDVVNRITSNASAIVTNAARALFSEQPQLIQPGGNAYTNRRMAACLRDMEIILRYVSYAIIAGDSSVLDDRCLNGLRETYQALGVPGASVAVGVEKMKDSAIAIANDPSGITTGDCSALMAEVGTYFDRAATAVQ

SEQ ID NO: 3 - protein, 161 aa, Galdieria sulphuraria
MSIVTKSIVNADAEARYLSPGELDRIKSFVLSGQRRLRIAQILTDNRERIVKQAGQQLFQQRPDIVSPGGNAYGEEMTATCLRDLDYYLRLVTYGVVAGDISPIEEIGLVGVKEMYNSLGTPISAVAEGIKAMKNVACSLLSGDDSAEAGFYFDYTIGAMQ

SEQ ID NO: 4 - protein, 161 aa, Galdieria sulphuraria
MQDAITAVINTADVQGKYLDNSSIEKLKGYFQTGELRVRAAATIAANAAGIIKDAVAKSLLYSDITRPGGNMYTTRRYAACIRDLDYYLRYATYSMLAGDPSILDERVLNGLKETYNSLGVPIGATIQSIQAMKEVTSSLVGSEAGKEMGIYFDYICSGLS

(19) United States
(12) Patent Application Publication
(10) Pub. No.: US 2024/0407416 A1
(43) Pub. Date: Dec. 12, 2024

(54) IMPROVED STABILIZATION OF PHYCOCYANINS IN ACIDIC COMPOSITIONS

(71) Applicant: THE WILLIAMSON GROUP, LLC, Louisville, KY (US)

(72) Inventors: Matthieu COURBALAY, BIEUJAC (FR); Axel ATHANE, CARBON BLANC (FR); Oliver CAGNAC, LIBOURNE (FR); Bryan AVILES, Louisville, KY (US); Jennifer JARVIS-CONLEY, Georgetown, IN (US); Jody RENNER-NANTZ, Louisville, KY (US)

(21) Appl. No.: 18/686,392

(22) PCT Filed: Aug. 24, 2022
(86) PCT No.: PCT/IB2022/000483

§ 371 Date: Feb. 23, 2024

Related U.S. Application Data
(60) Provisional application No. 63/236,444, filed on Aug. 24, 2021.

(51) Int. Cl. A23L 29/256; A23J 1/00; A23L 2/40; A23L 2/66; A23L 2/68

(52) U.S. Cl. CPC A23L 29/256; A23J 1/009; A23L 2/40; A23L 2/66; A23L 2/68

(57) ABSTRACT

The present technology generally relates to acidic compositions comprising stabilized phycocyanins as well as to methods for obtaining such acidic compositions.

### FIELD OF TECHNOLOGY

The present technology generally relates to acidic compositions comprising stabilized phycocyanins as well as to methods for obtaining such acidic compositions.

### BACKGROUND INFORMATION

Phycocyanins are food colourings which give a blue colour to the products to which they are added. Phycocyanins extracted from spirulina is today the only natural blue pigment approved by the FDA (FR Doc No: 2013-19550). It is sold in liquid form, or in powder form for use as blue pigment in foods.

That spirulina-derived phycocyanins, however, has the disadvantage of being unstable at acidic pH, below 5, leading to loss of colouring and to precipitation, which limit its use. In the best case, the loss of stability occurs around pH 4 (cf. technical specifications of the spirulina-derived phycocyanins Linablue®; http://www.dlt-spl.co.jp/business/en/spirulina/linablue.html). Consequently, there are many acidic food compositions, notably carbonated and non-carbonated beverages, for which spirulina-derived phycocyanins cannot be used as food colouring or for its antioxidant properties.

It was previously demonstrated in WO 2017/050918, incorporated herein by reference, that contrary to spirulina-derived phycocyanins, phycocyanins extracted from Galdieria or Cyanidiophycae has the ability to resist acidic pH.

However, the use of phycocyanins in an industrial context in acid beverages is much more complex. Indeed, tests have shown that after heat treatments such as during pasteurization, followed by accelerated aging tests, there was a significant loss of phycocyanins and that such loss was associated with a gradual change in colour with the appearance of green shades. Depending on the conditions, these changes in hue are total. This lack of stability can be an issue for the marketing of the product.

Sulphated polysaccharides, like lambda-carrageenans, have already been disclosed for stabilisation of spirulina-derived phycocyanins. However, it is not suitable to add large quantities of additives within food compositions.

In view of this, there is a need to identify ways of stabilizing phycocyanins or stabilizing the colouring provided by phycocyanins in the context of acidic compositions, notably acidic beverages.

### SUMMARY OF TECHNOLOGY

According to various aspects, the present technology relates to an acidic composition comprising phycocyanins, wherein the phycocyanins are present in the composition in an amount ranging from between about 0.001 and about 0.1 wt %.

According to various aspects, the present technology relates to a carbonated beverage comprising the acidic composition as defined herein.

According to various aspects, the present technology relates to a carbonated beverage consisting of the acidic composition as defined herein.

The inventors have surprisingly found that a low quantity of sulphated polysaccharide can be used for stabilizing phycocyanins in acidic compositions. As such, according to an aspect, the present technology relates to an acidic composition comprising phycocyanins and at least one sulphated polysaccharide, wherein the phycocyanins and the at least one sulphated polysaccharide are present in the composition in a ratio of between about 0.20:1 and about 20:1, preferably about 0.25:1 and about 10:1 or in a ratio of between about 0.3:1 and about 10:1, preferably between about 1:1 and about 10:1, still preferably between about 0.3:1 and about 0.6:1, between about 0.9:1 and about 2.4:1 or between about 0.3:1 and 1.5.

The present technology relates to an acidic composition comprising phycocyanins and at least one sulphated polysaccharide, wherein the phycocyanins and the at least one sulphated polysaccharide are present in the composition in a ratio of between about 0.25:1 and about 1:1.

In another embodiment, the present technology relates to an acidic composition comprising phycocyanins and at least one sulphated polysaccharide, wherein the phycocyanins and the at least one sulphated polysaccharide are present in the composition in a ratio of about 0.25:1, about 0.3:1, about 1:3, about 0.5:1, about 0.75:1, about 0.6:1, about 1:1, about 1.5:1, about 2:1, about 3:1, about 4:1, about 5:1 or about 6:1.

According to various aspects, the present technology relates to an acidic composition comprising a Galdieria extract, wherein the Galdieria extract is present in the composition in an amount ranging from between about 0.004 wt % and about 0.4 wt %.

According to various aspects, the present technology relates to a food product comprising an acidic composition as defined herein.

According to various aspects, the present technology relates to a food product consisting of an acidic composition as defined herein.

According to various aspects, the present technology relates to a concentrated liquid composition comprising phycocyanins, the phycocyanins being present in the concentrated composition in an amount ranging between about 50 mg/L and about 2500 mg/L.

According to various aspects, the present technology relates to a food product comprising the concentrated liquid composition as defined herein.

According to various aspects, the present technology relates to a food product consisting of the concentrated liquid composition as defined herein.

Other aspects and features of the present disclosure will become apparent to those ordinarily skilled in the art upon review of the following description of specific embodiments in conjunction with the accompanying drawings.

### BRIEF DESCRIPTION OF THE DRAWINGS

All features of embodiments which are described in this disclosure are not mutually exclusive and can be combined with one another. For example, elements of one embodiment can be utilized in the other embodiments without further mention. A detailed description of specific embodiments is provided herein below with reference to the accompanying drawings in which:

FIG. 1 is a picture showing results of heat stability test of phycocyanins over 4 hours in model beverage systems wherein model beverage systems comprise 0.1%, 0.2%, or 0.4% Galdieria extract and were all diluted to 0.1% after heating for visual comparison.

FIG. 2A is a picture showing 8-week stability of phycocyanins in a first series of model and electrolyte beverages comprising 0.2% Galdieria extract with or without vitamin C.

FIG. 2B shows tables of results after 8-week stability of phycocyanins in a first series of model and electrolyte beverages comprising 0.2% Galdieria extract with or without vitamin C.

FIG. 3A is a picture showing 8-week stability of phycocyanins in a second series of model beverages comprising 0.2% and 0.4% Galdieria extract with or without vitamin C.

FIG. 3B shows tables of results after 8-week stability of phycocyanins in a second series of model beverages comprising 0.2% and 0.4% Galdieria extract with or without vitamin C.

FIG. 4 is a picture showing the results of a stability test on model beverage with 0.01% and 0.02% Galdieria extract.

FIG. 5 is a picture the effects of High Temperature, Short Time pasteurization (HTST, also called flash pasteurization in the present application) pasteurization on stability of a model beverage comprising 0.01% Galdieria extract.

FIG. 6 is a picture the effects of Lambda carrageenan on stability of a model beverage comprising 0.01% Galdieria extract.

FIG. 7 shows the comparison of Galdieria extract—carrageenan (5:1) containing beverages to commercially available beverages Gatorade® and Powerade® (dE CMC 1.99).

FIG. 8 is a graph showing the effect of HTST pasteurization on dE CMC of beverages comprising differing ratios of Galdieria extract:Lambda carrageenan.

FIG. 9 is a chart presenting average dE CMC after HTST of different beverages of example 10ter.

FIG. 10 is a picture of beverages comprising different content of Galdieria extract (0.10% or 0.2% by weight relative to the total weight of the beverage) before (left bottles) and after (right bottles) HTST according to example 10ter.

FIG. 11 is a graphic representation showing average dE CMC after light test of different beverages according to example 10bis and 10ter.

FIG. 12 is a picture of several beverages comprising different content of Galdieria extract (0.1% or 0.2% by weight relative to the total weight of the beverage) with or without vitamin C, before (left bottles) and after (right bottles) light test according to example 10bis and 10ter.

FIG. 13 is a chart presenting average dE CMC after accelerated stability test of different beverages according to example 10ter.

FIG. 14 is a picture of several beverages comprising different content of Galdieria extract (0.1% or 0.2% by weight relative to the total weight of the beverage) before (left bottles) and after (right bottles) accelerated stability test according to example 10ter.

FIG. 15A is a picture of beverages comprising Galdieria extract and lambda carrageenan at different pH in a ratio 5:1.

FIG. 15B a table of hue measurements of beverages comprising Galdieria extract and lambda carrageenan at different pH in a ratio 5:1.

FIG. 16A is a picture of beverages comprising spirulina extract and lambda carrageenan at different pH in a ratio 5:1.

FIG. 16B is a table of hue measurements of beverages comprising spirulina extract and lambda carrageenan at different pH in a ratio 5:1.

FIG. 17A is a picture of beverages comprising Galdieria extract and lambda carrageenan at different pH in a ratio 1:1.

FIG. 17B is a table of hue measurements of beverages comprising Galdieria extract and lambda carrageenan at different pH in a ratio 1:1.

FIG. 18A is a picture of beverages comprising spirulina extract and lambda carrageenan at different pH in a ratio 1:1.

FIG. 18B is a table of hue measurements of beverages comprising spirulina extract and lambda carrageenan at different pH in a ratio 1:1.

FIG. 19 is a chart presenting average dE CMC after HTST of several beverages comprising either Galdieria or spirulina extract with different content of lambda carrageenan and different pH.

FIG. 20 is a chart presenting average dE CMC after HTST of several beverages comprising either Galdieria or spirulina extract with different content of lambda carrageenan and at pH 3.0 and 4.0.

### DETAILED DISCLOSURE OF EMBODIMENTS

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure which variations and additions do not depart from the present technology. Hence, the following description is intended to illustrate some particular embodiments of the technology, and not to exhaustively specify all permutations, combinations and variations thereof.

As used herein, the singular form “a,” “an” and “the” include plural referents unless the context clearly dictates otherwise.

The recitation herein of numerical ranges by endpoints is intended to include all numbers subsumed within that range (e.g., a recitation of 1 to 5 includes 1, 1.5, 2, 2.75, 3, 3.80, 4, 4.32, and 5).

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

As used herein, the term “comprise” is used in its non-limiting sense to mean that items following the word are included, but items not specifically mentioned are not excluded.

As used herein, the expression “wt %” and “%” are defined as the weight % of a component relative to the total weight of a composition, unless defined otherwise.

In the meaning of the present technology, the “stability” of phycocyanins refers to its capacity to retain its colour hue, intensity and limpidity in acidic environment under prolonged storage and/or heat treatment.

A phycocyanin is considered as having an improved or enhanced stability when less precipitation, less fuzziness and/or less significant colour change is observed after exposition to high temperatures and/or prolonged storage in the dark or light at ambient temperature. Precipitation and fuzziness can be observed with the naked eye and colour changes can be tracked by spectrophototometric methods by studying lambda max values or through colorimetric methods by determining dE CMC.

The color hue is measured using spectrophotometer for aqueous solution and DigiEye Color Measurement and Imaging System for semi-solid and solid composition. CIE L*a*b* value and hue angle (h) are calculated. Colorimeter measurements provide a numerical representation of color based upon Opponent Color Theory where CIE L*a*b* represents (CIELAB color space):

L* scale: Light vs. Dark where a low number (0-50) indicates Dark and a high number (51-100) indicates Light.

a* scale: Red vs Green where a positive number indicates Red and a negative number indicates Green.

b* scale: Yellow vs. Blue where a positive number indicates Yellow and a negative number indicates Blue.

$$Δ E = \sqrt{{( {L}_{1}^{*} - {L}_{0}^{*} )}^{2} + {( {a}_{1}^{*} - {a}_{0}^{*} )}^{2} + {( {b}_{1}^{*} - {b}_{0}^{*} )}^{2}}$$

dE is the overall measure of color difference. A colour change is considered as visible from a dE CMC of 2, and the higher the dE CMC, the higher instability of the phycocyanins. A dE CMC of 3 or lower is considered to indicate no visual change.

In acidic conditions, it is hypothesized that negatively charged multi-sulphated carrageenans, like for example lambda and iota carrageenan, form complexes with positively charged phycocyanins and prevents it from aggregating and stabilizes the color. A clear shift in color hue is observed with the addition of multi-sulphated carrageenan, like for example iota and lambda carrageenan, in acidic conditions.

In one embodiment, the present technology stems from experiments that showed that depending on the dose of phycocyanins used in a final product, the coloring effect was more or less pronounced. Counterintuitively, the more phycocyanins that were present in a composition, the more instability was obtained. On the other hand, at low concentration usage, the color changes were limited and sometimes barely visible to the human eye.

It was also determined that the addition of carrageenan improved heat stability of the phycocyanins. Generally, when exposed to High Temperature, Short Time pasteurization (HTST pasteurization, also called flash pasteurization), the colour of phycocyanins fades.

It was further determined that combining phycocyanin and carrageenans allow to create a colour hue that could be used to replace blue 1 in beverages. In particular, in preferred embodiment; the acidic composition according to the present technology comprises Galdieria's phycocyanins-carrageenans at a ratio of 5:1 (1.5:1 phycocyanins:carrageenans) and give a dE CMC between the Galdieria and blue 1 beverages of less than 2.5, therefore give a color matching the color of blue 1 containing beverages.

It was further determined that when concentrated phycocyanins (e.g., typically compositions comprising between about 0.3% and about 10% phycocyanins) was heated in acidic condition, a green extract was formed and that this green extract could be used in food and beverages applications. Thus, the present technology also relates to a method for producing a green color based on phycocyanins extracted from an alga or a microalga of the order of Cyanidiales preferably of the genera Cyanidioschyzon, Cyanidium or Galdieria still preferably from the species Galdieria sulphuraria, Cyanidium caldarium, or Cyanidioschyzon merolae In some embodiments, the phycocyanins useful in the present technology can be phycocyanins extracted from a Galdieriaceae, in some instances extracted from Galdieria. In some instances, phycocyanins are components of a Galdieria extract.

Typically, colorant in powder comprises between about 25% and about 30% of phycocyanins in order to exhibit an absorbance of a 10% dilution of the colorant of E10=180. For illustration purposes, 1 g of Galdieria extract would comprises between about 0.25 and about 0.30 g of phycocyanins mixed with at least one diluent such as water, invert sugar, sucrose, and/or maltodextrin.

In some embodiments, the phycocyanins of the present technology are extracted phycocyanins. Phycocyanins can be extracted from Galdieria using protocols known in the art and for example protocols such as those described in WO 2020/144331, incorporated herein by reference.

In some embodiments, the phycocyanins of the present technology are extracted phycocyanins. In some embodiments, the phycocyanins of the present technology are isolated phycocyanins. As used herein, the terms “extracted” and “isolated” refer to a compound isolated from a natural source (e.g., from Galdieria), for example using chromatography, distillation, extractions, or similar technique resulting in a greater than about 25%, about 30%, about 35%, about 40%, about 45%, about 50%, about 55%, about 60%, about 65%, about 75%, about 80%, about 85%, about 90%, about 95% or about 98% purity or about 99% purity.

In some embodiments, the phycocyanins of the present technology are purified phycocyanins, notably a purified extract of phycocyanins. By “purified extract” is meant a crude extract of which a portion of the water-soluble elements (proteins, ions, sugars) have been removed by liquid separation methods such as but not limited to: ultrafiltration, hollow-fibre filtration, or ion-exchange chromatography, methods known to those skilled in the art, while retaining the phycocyanins. In some embodiments, Galdieria extract as used herein is a purified Galdieria extract.

The total phycocyanins content, hereafter referred shortly as “phycocyanins”, is the sum of the C-phycocyanin and allophycocyanin when presents.

In some embodiments the “purified” compounds disclosed herein have greater than 70% purity. In some embodiments the “purified” compounds disclosed herein have greater than 80% purity. In some embodiments the “purified” compounds disclosed herein have greater than 90% purity, greater than 95% purity, or greater than 98% purity.

Phycocyanins are phycobiliproteins comprising alpha and beta subunits composed of an apoprotein covalently bound to a chromophore. The different phycocyanins are distinguished essentially by the sequence of their alpha- and beta-subunit apoproteins.

According to a particular embodiment, the acidic composition, particularly the acidic food composition of the present technology, comprises an acidic-pH-resistant phycocyanin whose α-subunit apoprotein comprises SEQ ID NO: 1 (accession number YP_009051179.1) and whose β-subunit apoprotein comprises SEQ ID NO: 2 (accession number YP_009051180.1) or variants thereof.

In some embodiments, the present technology relates to acidic compositions comprising phycocyanins. In some embodiments, the acidic compositions comprise extracted phycocyanins, isolated phycocyanins or purified phycocyanins.

The acidic composition of the present technology may be an acidic food composition that can be solid, pasty, or liquid. In some instances, the acidic food composition is a carbonated beverage. In some other instances, the acidic food composition is a dairy product, such as, but not limited to: a yogurt.

By acidic composition, particularly by acidic food composition, is meant, according to the present technology, a composition having a pH of 4.0 or less, advantageously having a pH of between about 2.5 and about 3.5, advantageously higher than about 3.0 and lower or equal to about 4.0.

In some embodiments, the acidic composition, particularly the acidic food composition, comprises acidic-pH-resistant phycocyanins whose α-subunit apoprotein has an amino acid sequence as set forth in SEQ ID NO: 1 (accession number YP_009051179.1) or a variant thereof and whose β-subunit apoprotein has an amino acid sequence as set forth in SEQ ID: 2 (accession number YP_009051180.1) or a variant thereof.

In some embodiments, the acidic composition, particularly the acidic food composition, can further comprise an allophycocyanin combined with the C-phycocyanin.

In some instances, the alpha-subunit apoprotein of said allophycocyanin has an amino acid sequence as set forth in SEQ ID NO: 3 (accession number YP_009051103.1) or a variant thereof and the β-subunit apoprotein has an amino acid sequence as set forth in SEQ ID NO: 4 (YP_009051104.1) or a variant thereof.

In some embodiments, the alpha-subunit apoprotein of said allophycocyanin consists of an amino acid sequence as set forth in SEQ ID NO: 3 (accession number YP_009051103.1) or a variant thereof and the β-subunit apoprotein consists of an amino acid sequence as set forth in SEQ ID NO: 4 (YP_009051104.1) or a variant thereof.

The characteristics of a protein depend, among other things, on its amino acid composition and its isoelectric point (pI). The isoelectric point is the pH of the solution at which the protein carries no net charge or, in other words, the pH at which the molecule is electrically neutral and the proteins tend to attract one another, aggregate and precipitate. At a pH above their isoelectric point, the proteins tend to be negatively charged and to repel one another.

Comparative analysis of the isoelectric points of various proteins using the computational procedure described by Patrickios and Yamasaki (Polypeptide Amino Acid Composition and Isoelectric Point. II. Comparison between Experiment and Theory. Analytical Biochemistry. 231, 1, 1995: 82-91.1995) shows a certain correlation between the theoretical calculations and the acidic pH resistance observed experimentally.

Studies carried out by the Applicant indicate that the acidic pH resistance of a phycocyanin may be linked to the amino acid sequence of the a subunit of said phycocyanin. Furthermore, it is noted that within the amino acid sequence of the a subunit of the phycocyanin, the identity of the first 26 amino acids seems particularly important. It is particularly the case of phycocyanin obtained by culture of microalgae strains of the genera Cyanidioschyzon, Cyanidium or Galdieria, more particularly of strains Galdieria sulphuraria, Cyanidium caldarium and Cyanidioschyzon merolae.

In some embodiments, the composition of the present technology can comprise at least one phycocyanin of which at least one apoprotein, particularly that of the α-subunit, can have a low isoelectric point allowing better stability at acidic pH. By low isoelectric point is meant an isoelectric point of 3 or less, preferentially of 2.5 or less, more preferentially of 2.2 or less. In some embodiments, the composition of the present technology can comprise at least one phycocyanin of which at least one apoprotein, particularly that of the a subunit, can have an isoelectric point of 3 or less, preferentially of 2.5 or less, more preferentially of 2.2 or less.

The acidic composition, particularly the acidic food composition, can comprise at least one phycocyanin whose α-subunit apoprotein can have a low isoelectric point, more particularly at least one phycocyanin whose α-subunit apoprotein can comprise an amino acid sequence as set forth in SEQ ID NO: 1, or a variant thereof.

In some embodiments, the acidic composition, particularly the acidic food composition, comprises at least one phycocyanin whose α-subunit apoprotein has a low isoelectric point, more particularly at least one phycocyanin whose α-subunit apoprotein consists of an amino acid sequence as set forth in SEQ ID NO: 1, or a variant thereof.

As used herein, the term “variant” refers to a protein sequence corresponding to a reference sequence, in this case the protein represented by SEQ ID NO: 1 or SEQ ID NO: 2 or SEQ NO: 4, modified by one or more substitutions, insertions or deletions of one or more amino acids of the reference sequence and which has the same functional properties as said reference sequence, in particular the same stability in acidic environments.

In some instances, the variants of the present technology have at least about 83% sequence identity with the α-subunits of the phycocyanin, and at least about 82% with the beta subunits of the phycocyanin. In some other instances. In some instances, the variants of the present technology have at least about 90% identity with the α (SEQ ID NO: 1) and β (SEQ ID NO: 2) subunits, preferably at least about 95%, 96%, 97%, 98%, 99% identity with the α (SEQ ID NO: 1) and β (SEQ ID NO: 2) subunits.

Similarly, for the allophycocyanins, the variants have at least about 89% sequence identity with the a subunits of the allophycocyanin, and at least about 90% with the β subunits of the allophycocyanin.

Those skilled in the art know how to measure protein sequence identity using the common methods at their disposal, notably the BLASTP program (http://blast.ncbi.nlm.nih.gov/Blast.cgi).

Identification of variants that are encompassed by the present technology may be identified using methods known in the art such as by verifying that the variants retain the same structural and functional properties as the original amino acid sequence by a stability test in acidic pH, for example by performing a test such as the test presented in the Examples of the present application.

The polypeptides of the present technology can be modified by substitution, insertion and/or deletion of at least one amino acid without substantially modifying the function thereof. For example, the substitution of an amino acid at a given position by another chemically equivalent amino acid is a known example of sequence variation which does not substantially affect the properties of the protein. These “conservative” substitutions can be defined as exchanges within the following groups of amino acids: i) Ala, Ser, Thr, Pro, Gly; ii) Asp, Asn, Glu, Gln; iii) His, Arg, Lys; iv) Met, Leu, Ile, Val, Cys; and v) Phe, Tyr, Trp.

Thus, the variants of the apoproteins of the C-phycocyanins and/or allophycocyanins according to the present technology can comprise a difference of between 1 and 30 amino acids in relation to the corresponding reference sequence. In some instances, the variants of the apoproteins of the C-phycocyanins and/or allophycocyanins according to the present technology can comprise a difference of 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 amino acids in relation to the corresponding reference sequence. In some instances, a variant of the α and/or β subunits of the phycocyanin, retains the properties of the reference protein and the percent homologies/identities stated above.

In some embodiments, the α-subunit apoprotein variants of the phycocyanins useful in the acidic compositions of the present technology, deriving from substitutions, insertions and/or deletions, can comprise a difference of 1 to 27 amino acids in relation to the corresponding reference sequence, insofar as the variant obtained retains the properties of the reference protein and the percent identities stated above.

In some embodiments, the α-subunit apoprotein variants of the phycocyanins useful in the acidic compositions of the present technology and the β-subunit apoprotein variants of the phycocyanins useful in the acidic compositions according to the present technology, deriving from substitutions, insertions and/or deletions of a reference sequence, can comprise a difference of 1 to 30 amino acids in relation to the corresponding reference sequence, insofar as the variant obtained retains the properties of the reference protein and the percent identities stated above.

In some embodiments, the α-subunit apoprotein variants of the C-phycocyanins useful in the acidic compositions of the present technology, the α-subunit apoprotein variants of the allophycocyanins useful in the acidic compositions according to the present technology, deriving from substitutions, insertions or deletions, can comprise a difference of 1 to 24 amino acids in relation to the corresponding reference sequence, insofar as the variant obtained retains the properties of the reference protein and the percent identities stated above.

In some embodiments, the α-subunit apoprotein variants of the C-phycocyanins useful in the acidic compositions of the present technology, the β-subunit apoprotein variants of the allophycocyanins useful in the acidic compositions according to the present technology, deriving from substitutions, insertions and/or deletions, can comprise a difference of 1 to 20 amino acids in relation to the corresponding reference sequence, insofar as the variant obtained retains the properties of the reference protein and the percent identities stated above.

Regardless of the reference sequence considered (phycocyanin α and/or β subunit and/or allophycocyanin α and/or β subunit), the variants of said subunits can comprise a difference of 1 to 15 amino acids, preferably a difference of 1 to 10 amino acids, in particular a difference of 1 or 2 or 3 or 4 or 5 or 6 or 7 or 8 or 9 or 10 amino acids in relation to the corresponding reference sequence, insofar as the variant obtained retains the properties of the reference protein and the percent identities stated above.

In some embodiments, the C-phycocyanin or variants thereof useful, alone or mixed with an allophycocyanin or variants thereof, in acidic compositions, particularly in acidic food compositions, can be obtained by culture of a natural organism naturally expressing the C-phycocyanin or the variant thereof of interest or by culture of an organism genetically transformed to express the C-phycocyanin or the variant thereof of interest selected for its capacity to produce said C-phycocyanin or variants thereof. Examples of natural organisms naturally expressing a C-phycocyanin useful in the compositions according to present technology or the variant thereof of interest include algae or microalgae of the order Cyanidiales. The order Cyanidiales includes the families Cyanidiaceae and Galdieriaceae, themselves subdivided in the genera Cyanidioschyzon, Cyanidium and Galdieria, members of which include, among others, the species Cyanidioschyzon merolae 10D, Cyanidioschyzon merolae DBV201, Cyanidium caldarium, Cyanidium daedalum, Cyanidium maximum, Cyanidium partitum, Cyanidium rumpens, Galdieria daedala, Galdieria maxima, Galdieria partita, Galdieria phlegrea, and Galdieria sulphuraria. Particular mention may be made of strain Galdieria sulphuraria (also called Cyanidium caldarium).

Thus, according to an embodiment of the present technology, the acidic composition, particularly the acidic food composition, comprises acidic-pH-resistant phycocyanins from natural organisms such as algae or microalgae of the order Cyanidiales, in particular from natural organisms of the families Cyanidiaceae or Galdieriaceae. In some instances, the acidic composition, particularly the acidic food composition, comprises acidic-pH-resistant phycocyanins from natural organisms which belong to the genera Cyanidioschyzon, Cyanidium, Galdieria, advantageously selected from the species of the genera Cyanidium and Galdieria. In some other instances, the acidic composition, particularly the acidic food composition, comprises acidic-pH-resistant phycocyanins from natural organisms selected from the species Cyanidioschyzon merolae 10D, Cyanidioschyzon merolae DBV201, Cyanidium caldarium, Cyanidium daedalum, Cyanidium maximum, Cyanidium partitum, Cyanidium rumpens, Galdieria daedala, Galdieria maxima, Galdieria partita, Galdieria phlegrea, Galdieria sulphuraria.

In some further instances, the acidic food composition, according to the present technology comprises acidic-pH-resistant phycocyanins from a natural microalga such as Galdieria sulphuraria, Cyanidium caldarium or Cyanidioschyzon merolae. More preferentially, the acidic-pH-resistant phycocyanins comes from a natural microalga selected from Galdieria sulphuraria and Cyanidium caldarium.

By way of example of an organism transformed to express the phycocyanin or the variant thereof of interest selected for its capacity to produce said phycocyanin or variants thereof, mention may be made of a microorganism transformed so as to express the apoprotein of SEQ ID NO: 1 and/or SEQ ID NO: 2 and/or SEQ ID NO: 3 and/or SEQ ID NO: 4, said microorganism also comprising the biosynthetic pathways necessary for the production of the chromophore and for the binding thereof to the apoprotein. Yeasts in particular may be mentioned as microorganisms that can be modified to produce the C-phycocyanin and/or allophycocyanin used in the food compositions according to the present technology. Methods for culturing natural and/or modified organisms that can produce a phycocyanin useful in the compositions according to the present technology are known in the art. For example, the culture of Cyanidiaceae or Galdieriaceae, of the order Cyanidiales, well-known to those skilled in the art, can be carried out in mixotrophic mode, light usually being necessary for the biosynthesis of pigments. Such an industrial culture can be carried out in large-volume (i.e., 1,000-litre, 10,000-litre, 20,000-litre, 100,000-litre) fermenters. The culture can be carried out under the conditions known to those skilled in the art. It can be carried out in batch mode, in fed-batch mode or in continuous mode.

The phycocyanin useful in the compositions according to the present technology can be extracted from biomass obtained by culture of an alga of the order Cyanidiales, as defined above, cultivated in mixotrophic mode with light having a wavelength of between about 400 nm and about 550 nm, or between about 420 nm and about 500 nm, or between about 430 and about 480 nm, or about 455 nm. It can be “white” light having a broad-spectrum comprising light of said wavelength. It can also be narrow spectrum light consisting of said wavelength. Such a method for industrial preparation of Cyanidiales biomass in mixotrophic mode, and the biomass thus obtained, are in particular described in patent application FR 15 59072, the contents of which are incorporated herein by reference.

An object of the present technology is to provide an acidic composition in which the phycocyanin demonstrates improved or enhanced stability at acidic pH. By acidic composition is meant, according to the present technology, any composition comprising a mineral or organic acid and a phycocyanin. Said composition can be liquid, fluid or viscous, pasty or solid, which has an acidic pH and into which an acidic-pH-resistant phycocyanin is incorporated. By “improved” or “enhanced” stability at acidic pH is meant that upon heat and/or storage treatment of the solution containing phycocyanin, the colour intensity is better maintained. The enhancement can be measured through spectrophototometric methods tracking lambda max values or through colorimetric methods tracking dE CMC.

For the aqueous liquid compositions, the pH is measured in the usual manner. For the non-aqueous liquid compositions or for the pasty or solid compositions, the pH is measured after dissolution of the composition in a sufficient amount of water to dissolve the soluble compounds contained therein, including the mineral or organic acids and the phycocyanin. Examples of mineral acids that can be used in the compositions of the present technology include, but are not limited to, carbonic, phosphoric, hydrochloric, sulphuric, perchloric, sulphonic and nitric acids. Other examples include organic acids such as citric acid, lactic acid, malic acid, tartaric acid, and succinic acid.

In some embodiments, the composition according to the present technology is an aqueous liquid composition, optionally in gel form, or a pasty or solid composition designed to be dissolved in an aqueous solution or in a solid or pasty composition comprising water. According to other embodiments of the present technology, the acidic composition pasty or solid composition intended to be employed and/or stored in a humid environment.

By acidic food composition is meant, according to the present technology, any composition designed to be ingested by humans or animals and which falls within the preceding definition. Nutraceutical acidic compositions must be regarded as falling within the definition of the acidic food compositions within the context of the present technology.

The acidic food compositions according to the present technology are well known to those skilled in the art. They can comprise a carrier which can comprise structural components associated with active compounds identified for their nutritive supply or for their health properties which benefit humans or animals. The acidic food composition according to the present technology can also comprise food additives such as texturing agents, flavouring agents, preservatives, or any components well known to those skilled in the art. The carrier can comprise water and/or proteins and/or fats and/or fibre and/or sugars. The components of the carrier may have only structural properties, but they are generally known for their nutritive supply.

The acidic food composition according to the present technology can be ready-to-use or in the form of a food additive to be added to a solid, pasty or liquid preparation in order to prepare the edible food.

For the food compositions, the acid may be selected from the list of acidifiers authorized for foods, in particular carbonic, phosphoric, citric, malic, tartaric, lactic acids, and citric acid.

Concerning the non-food acidic compositions according to the present technology, they can be, among other things, pharmaceutical, veterinary or cosmetic compositions and further comprise any additives and/or active agents known and used in such compositions.

In a solid, liquid or pasty acidic composition according to the present technology, the phycocyanin can be incorporated, for example, in powder form. Said acidic composition, particularly said acidic food composition, may thus be in any known conventional form such as creams, gels, foams, pastes, etc. Examples of solid food compositions include cakes or biscuits, dry food for cooking, soluble powders, gelatinous solid compositions (jelly), foams etc.

According to the present technology, said liquid acidic composition can be an aqueous composition into which the phycocyanin is dissolved. It can be in the form of a ready-to-use composition or a liquid concentrate for dilution, notably to be ingested or to be added to a solid food either for its preparation or for its ingestion, for example a concentrated liquid “topping” composition to be applied to a cake to give it colour. Among these concentrated compositions, mention may be made of syrups, optionally containing alcohol.

The liquid acidic composition according to the present technology can be of varying viscosity and may comprise additives such as viscosity agents, gelling agents, and other structuring additives known to those skilled in the art and typical for the preparation of liquid food compositions.

According to one embodiment of the present technology, the liquid food composition is a carbonated acidic beverage. Particular mentions may be made of sodas, juices, sports drinks, energy drinks, recovery drinks, etc. The compositions of these beverages are well known to those skilled in the art and can notably comprise sugars, mineral salts, food additives, dissolved gas, etc. The beverage according to the present technology is a conventional acidic beverage in which the colouring usually employed has been wholly or partly replaced by an acidic-pH-resistant phycocyanin according to the present technology.

The inventors found that, in a counter-intuitive way, the more phycocyanin is concentrated in the composition, the less stable they are thus the more the colour of the final product is modified. Therefore, it is recommended to decrease phycocyanins, in particular C-phycocyanins, content in order to have a more colorful product, in other word to decrease the quantity of coloring agent to increase the color of the product.

In some embodiments, phycocyanin is present in the acidic composition of the present technology in an amount that allows for improved stabilisation of the phycocyanin, also called “low content” hereafter. In some instances, phycocyanin is present in the acidic compositions in an amount ranging between about 0.001 and about 0.1 wt %, or between about 0.001 and about 0.05 wt %, or between about 0.001 and about 0.025 wt %, or between about 0.0025 and about 0.010 wt %, or between about 0.0025 and about 0.005 wt %. In some instances, phycocyanin is present in the acidic compositions in an amount ranging between about 2.5 mg/L and about 2500 mg/L, between about 25 mg/L and about 300 mg/L, or between about 50 mg/L and about 100 mg/L. In some implementations of these embodiments, the acidic composition is a liquid acidic composition.

In embodiments where the acidic composition is a ready-to-use beverage type, the phycocyanin content can range between about 25 mg/L and about 300 mg/L, or between about 50 mg/L and about 100 mg/L.

In embodiments where the acidic composition is a concentrated liquid composition for dilution before use (e.g., syrup), the phycocyanin content can range between about 50 mg/L and about 2500 mg/L, or between about 500 mg/L and about 1000 mg/L.

In embodiments where the acidic composition is a solid composition, the phycocyanin content can range between about 0.01 mg/g and about 10 mg/g, or between about 0.1 mg/g and about 5.0 mg/g, or between about 0.25 mg/g and about 2.5 mg/g.

In some embodiments, Galdieria extract is present in the acidic composition of the present technology in an amount that allows improved stability of the phycocyanin. In some instances, the Galdieria extract is present in the acidic compositions in an amount ranging between about 0.004 and about 0.4 wt %, or between about 0.004 and about 0.2 wt %, or between about 0.004 and about 0.1 wt %, or between about 0.01 and about 0.04 wt %, or between about 0.01 and about 0.02 wt %. In some instances, the Galdieria extract is present in the acidic compositions in an amount ranging between about 10 mg/L and about 10 g/L, between about 100 mg/L and about 1200 mg/L, or between about 200 mg/L and about 400 mg/L. In some implementations of these embodiments, the acidic composition is a liquid acidic composition.

In embodiments where the acidic composition is a ready-to-use beverage type, the Galdieria extract content can range between about 100 mg/L and about 1200 mg/L, or between about 200 mg/L and about 400 mg/L.

In embodiments where the acidic composition is a concentrated liquid composition for dilution before use (e.g., syrup), the Galdieria extract content can range between about 200 mg/L and about 10 g/L, or between about 2000 mg/L and about 4000 mg/L.

In embodiments where the acidic composition is a solid composition, the Galdieria extract content can range between about 0.04 mg/g and about 40 mg/g, or between about 0.4 mg/g and about 20 mg/g, or between about 1 mg/g and about 10 mg/g.

In some embodiments, the compositions of the present technology further comprise one or more sulphated polysaccharides. In some instances, the one or more sulphated polysaccharide is a multi-sulphated Carrageenan. Carrageenans are sourced from seaweed and they are highly flexible molecules that can form curling helical structures. Carrageenans are characterized as linear polysaccharides with repeating galactose units. Carrageenans are classified by the degree of sulfonation. Examples of mono-sulphated carrageenans are k-carrageenan, g-carrageenan and ocarrageenan. Examples of di-sulphated carrageenans are i-carrageenan, d-carrageenan, m-carrageenan and q-carrageenan. Examples of tri-sulphated carrageenans are l-carrageenan and v-carrageenan.

Multi-sulphated carrageenans are carrageenans containing at least 2 sulphate groups, preferably 2 or 3 sulphate groups per disaccharide unit. Examples of multi-sulphated carrageenans that may be used in the present technology include, but are not limited to: i-carrageenan, d-carrageenan, m-carrageenan, 0-carrageenan, l-carrageenan and v-carrageenan, the hydrolysed products of i-carrageenan, d-carrageenan, m-carrageenan, 0-carrageenan, l-carrageenan and v-carrageenan; more preferred are i-carrageenan and l-carrageenan, and its hydrolyzed products and most preferred is l-carrageenan and hydrolyzed l-carrageenan.

In some embodiments, the carrageenans content of the compositions of the present technology ranges between about 0.006 wt % and about 0.6 wt %, or between about 0.02 wt % and about 0.5 wt %, or between 0.03 wt % and about 0.4 wt %, or between about 0.05 wt % and about 0.3 wt %, or between about 0.005 wt % and about 0.1 wt %, or between about 0.001 wt % and about 0.1 wt %, or between about 0.05 wt % and about 0.1 wt %.

In some embodiments, the weight ratio phycocyanins extract to carrageenan present in the acidic compositions of the present technology depends on the water content and the pH of the composition. At high water content of at least about 45 wt % and at most about 95 wt %, the weight ratio between phycocyanins extract (phycocyanins extract containing about 25% to about 30% phycocyanins) and carrageenan (phycocyanins extract:carrageenans) ranges between about 1:1 and about 10:1, or between about 1:1 and about 5:1, or between about 1:1 and about 4:1, or between about 1:1 and about 3:1, or between about 1:1 and about 2:1. In some embodiments, the pH of the composition at this high-water content ranges between about 2.0 and about 3.7, or between about 2.2 and about 3.5, or between about 2.3 and about 3.3.

At low water content of at least 15 and less than 45 wt % water, the weight ratio between phycocyanins extract (phycocyanins extract containing about 25% to about 30% phycocyanins) and carrageenan ranges between 1:1.5, preferably 1:1, and 10:1 at a pH of at least about 2 and less than about 2.5. The weight ratio between phycocyanin and carrageenan ranges between about 1:2, preferably 1:1, and about 10:1 at a pH of at least about 2.5 and less than about 2.9, and the weight ratio between phycocyanins extract and carrageenans ranges between about 1:1 and about 10:1 at a pH of at least about 2.9 and less than about 4. The phycocyanins and carrageenans are preferably dissolved in the liquid feedstock. Dissolved means that as the phycocyanins and carrageenans stay in the aqueous solution. The solution is clear to the eye and does not show sediment or floating particulates.

It is known that the phycocyanin configuration impacts color hue. As pH decreases and the equilibrium of C-phycocyanin is shifted to monomers, the color hue shifts from dark blue to blue green (Buchweitz, 2016). In general, at pH values of 3.9 and less the equilibrium of C-phycocyanin is shifted to monomers. The color performance is assessed using hue measurements (CIE L*a*b* and h values, cf. hereabove) and the total sum of blue absorbance.

Without being bound to any theory, in acidic conditions, it is hypothesized that negatively charged multi-sulphated carrageenans, like for example lambda and iota carrageenan, form complexes with positively charged phycocyanins and prevents it from aggregating and stabilizes the color. However, a clear shift in color hue is observed with the addition of multi-sulphated carrageenan, like for example iota and lambda carrageenan, in acidic conditions, in particular at pH between 2.6 and 4.0. The addition of carrageenan shifts the color hue to be lighter (higher L*) and less blue/more yellow (higher b*).

The standard method for the phycocyanins determination was established by Yoshikawa & Belay (2008) to calculate the native phycocyanins content (mg/ml) from photometric measurements. It relies upon absorbance measurements at 620 and 650 nm and the extinction coefficients of C-phycocyanin and allophycocyanin at these wavelengths at pH 6.0. The addition of multi-sulphated carrageenan changes the shape of phycocyanins peak and in some cases, the peak maximum shifts from 620 nm to between 660-670 nm. Calculating phycocyanins content using only absorbance measurements at 620 and 650 nm would underestimate phycocyanins content for solutions containing multi-sulphated carrageenan. Thus, to determine the magnitude of color retention, the sum of the blue absorbance measurements at A620 nm-A750 nm, A650 nm-A750 nm, and A667 nm-750 nm are calculated and used. The total phycocyanins content in a spirulina-extract is calculated using Yoshikawa & Belay (2008) method at pH 6.0 which is listed below.

$$\begin{matrix}Allophycocanin ( \frac{mg}{mL} ) = 0.18 ( A 650 nm - A 750 nm ) - 0.0 \; 42 ( A 620 nm - A 750 nm ) \\ C ‐ phycocyanin ( \frac{mg}{mL} ) = 0.162 ( A 620 nm - A 750 nm ) - 0.0 \; 98 ( A 650 nm - A 750 nm ) \\ Total phycocyanins ( \frac{mg}{mL} ) = Allophycocanin ( \frac{mg}{mL} ) + C ‐ phycocyanin ( \frac{mg}{mL} )\end{matrix}$$

To determine the amount of C-phycocyanins added to a composition, the dosage level of Galdieria extract is multiplied by the total C-phycocyanins content in the Galdieria extract.

In some embodiments, the phycocyanins content of the liquid composition is between about 0.001 wt % and about 0.1 wt %, or between about 0.003 wt % and about 0.5 wt %, or between about 0.007 wt % and about 0.4 wt %, or between about 0.01 wt % and about 0.4 wt %.

The challenge with phycocyanins containing spirulina-extracts is the application to acidified aqueous systems. Spirulina proteins (including phycocyanins) precipitate out of solution when the pH is between about 2.7 and about 6.0. Precipitation may occur immediately or after a few weeks and this is dependent upon factors such as the viscosity, ionic strength, order of addition, temperature, and pH of the solution. The aggregation/precipitation is assessed visually and can be a cause for the color loss. High absorbance at 750 nm after acidification and/or processing can indicate a strong potential for protein aggregation/precipitation.

In some embodiments, the acidic composition according to the technology has a pH lower than 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1 and still preferably, the pH is higher or equal to 2.0.

The combination of a low content of phycocyanins from Galdieria and at least one sulphated polysaccharide, notably lambda carrageenan, at a ratio between 0.3:1 to 0.6:1 under a pH higher than 3.0 and lower or equal to 4.0 is particularly advantageous.

In some embodiments, the compositions of the present technology comprise additional components such as for example sweeteners, stabilizers, chelating agents, acids, proteins, salts, flavors, vitamins, minerals, pigments, thickeners and preservatives.

The compositions of the present technology may have a blue color due to the phycocyanins content, but other colors based on blue may be obtained by way of mixing other pigments in with the composition. The composition may contain other pigments, such as safflomin (safflower), anthocyanin, carotenoid, betanin, annatto, lycopene, curcumin and chlorophyll. The pigments may be added to the blue colored phycocyanin containing composition to blend into other colors, such as for example green using safflomin.

Examples of sweeteners are invert sugar, sucrose, high fructose corn syrup, corn syrup, fructose, glucose, trehalose, lactose, honey, agave, stevia, sucralose, aspartame, neotame, acesulfame potassium, monk fruit, or saccharine. Examples of preservatives are salts, sorbic acid, benzoic acid, natamycin, nisin and sulfites. Examples of salts are ionic compounds that can be formed with the positively charged cation such as calcium, magnesium, potassium, sodium, or copper with salt forming anions like for example acetate, carbonate, chloride, citrate, oxide, phosphate, sorbate, benzoate, hexametaphosphate or sulfate. Examples of acids are phosphoric, citric, lactic, malic, adipic, tartaric acid or sodium acid pyrophosphate. Examples of thickeners are gelatin, starch, pectin, konjac, or agar.

The composition according to the technology may contain chelators, which may also be referred to as chelating agents. Chelators are binding agents that influence the chemical and/or physical state of the molecules/atoms they bind by forming chelates. Chelators can improve color retention and have been found to work synergistically with the multi-sulphated carrageenans. Chelating agents can be synthetic and natural compounds and is particularly selected from the group of ethylene diamine tetra acetic acid and/or its Na, K, Ca salts (EDTA), L-glutamic acid N,N-diacetic acid tetrasodium salt (GLDA), sodium hexametaphosphate, glutathione, metallothionein, 2,3-dimercapto-1-propanesulfonic acid, chlorella, garlic, cilantro, selenium, milk thistle, vitamin C, vitamin E, citrates, grape seed extract, quercetin, and lipoic acid. Preferably, the chelating agents are selected from the group of ethylene diamine tetra acetic acid and/or its Na, K, Ca salts (EDTA) and L-glutamic acid N,N-diacetic acid tetrasodium salt (GLDA). EDTA is considered to be ethylene diamine tetra acetic acid together with its Na, K, Ca salts, like for example calcium disodium ethylenediaminetetraacetate, disodium ethylenediaminetetraacetate, tetrasodium ethylenediaminetetraacetate, dipotassium ethylenediaminetetraacetate, and tripotassium ethylenediaminetetraacetate. Calcium disodium ethylenediaminetetraacetate is abbreviated to CaNa₂ EDTA, disodium ethylenediaminetetraacetate is abbreviated to Na₂ EDTA, tetrasodium ethylenediaminetetraacetate is abbreviated to Na₄ EDTA, dipotassium ethylenediaminetetraacetate is abbreviated to K₂ EDTA, and tripotassium ethylenediaminetetraacetate is abbreviated to K₃ EDTA. Still preferably the chelating agent is vitamin C and/or EDTA. The chelating agent may be present in an amount ranging between about 1 and about 2000 ppm in the composition. 1 ppm of chelating agent is to be understood as 0.0001 wt %; for example, 30 ppm of EDTA are 0.003 wt %. EDTA may be present in the composition in an amount ranging between about 10 and about 300 ppm, or between about 15 and about 200 ppm, or between about 20 and about 100 ppm.

The EDTA and phycocyanins (such as a phycocyanins from a Galdieria extract) are preferably present within the composition of the present technology at a weight ratio between about 4:1 and about 1:200, or between about 2:1 and about 1:125, or between about 1:1 and about 1:75.

Compositions are typically transported and stored before being consumed. To assure that these compositions do not spoil and are safe for consumption, either thermal processes, preservatives, water activity, or combination of above are used.

A considerable blue color loss is observed upon high temperature short time (210° C. for 6 seconds) processing and when preservatives are used for solutions without carrageenans.

The composition can be obtained according to a process comprising the following steps: a) Adding and dissolving the multi-sulphated carrageenan in water and mixing until the multi-sulphated carrageenans are dissolved, as determined by visual observation; b) Adding the phycocyanins containing Galdieria-extract, and mixing until dissolved at a pH of at least 5, preferably at a pH between 5 and 10; c) Adding an acid or acidifying component; d) Optionally adding a sweetener, flavor, vitamins, minerals, salts, buffers, or other beverage components; e) Optionally adding a chelating agent, such as EDTA; f) Optionally adding other pigments, such as anthocyanins; g) Optionally adding an additive, such as preservatives; h) Treating the mixture of a)-h) by either thermally processing the liquid to at least 65° C.; or no thermal treatment and cold filling, or combinations of the two. It is important that phycocyanins containing Galdieria extract is added to dissolved multi-sulphated carrageenan optionally in presence of other components at a pH of 5.0 and above. List of compounds that may destabilize phycocyanins includes but is not limited to acid, anthocyanins, safflower, and alcohol. Acids can be used to prepare a hydrolyzed carrageenan, but the charges of the hydrolyzed carrageenan should be neutralized to a pH of at least 5 before mixing with the phycocyanins.

Components that do not destabilize phycocyanins, can be added during or before step a) of the process. Multi-sulphated carrageenan can for example be dry blended with a non-acidic carbohydrate such as sucrose or maltodextrin to improve dissolution. Step c) (adding of the acid or acidifying component) can be done before or after steps d), e), or f). Step h) is preferably performed after steps a)-g). If present, preservatives (step g) preferably are added before or during a) step due to solubility limitations of the preservatives.

Carrageenans are linear polysaccharides with repeating sulphated galactose units. The glycosidic linkages between galactose units are subject to hydrolysis with heat and acid. Hydrolyzed multi-sulphated carrageenan is found to also stabilize phycocyanins, however, charges of hydrolyzed multi-sulphated carrageenan must be neutralized to a pH above 5 prior to complexing with phycocyanins. Both hydrolyzed and non-degraded multi-sulphated carrageenan should have a pH above 5 prior to the addition of phycocyanins to prevent precipitation. Preferably the pH of the solution containing multi-sulphated carrageenan is between 5 and 10, more preferably between 5.5 and 9.9 before addition of phycocyanins.

The present technology relates also to a method for producing a green color comprising a step of heating phycocyanins in an aqueous solution at a pH of about 3.6 or lower than 3.6 at a temperature from about 30° C. to about 90° C., wherein phycocyanins are extracted from an alga or a microalga of the order of Cyanidiales preferably of the genera Cyanidioschyzon, Cyanidium or Galdieria still preferably from the species Galdieria sulphuraria, Cyanidium caldarium, or Cyanidioschyzon merolae.

In a preferred embodiment, the aqueous solution comprises between about 0.3% and about 10% of phycocyanins, still preferably between about 0.1% and about 1% of phycocyanins.

In a particular embodiment, the method for producing the green color is characterized in that the heating temperature is from about 30° C. to about 90° C., notably higher than or equal to about 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C. Still preferably the heating temperature is from about 40° C. to about 90° C., in particular from about 50° C. to about 85° C. and even more preferably from about 60° C. to about 80° C.

In a particular embodiment, the method for producing the green color is characterized in that the pH of the aqueous solution is preferably between about 2.0 and 4.0, still preferably around 3.0.

According to a particular embodiment, the method for producing a green color comprises preferably the use of phycocyanins that is acidic-pH-resistant phycocyanins having amino acid sequences, structure and functional properties as the ones described above.

The heating step of the method for producing a green color may have a duration comprised between about 1 minute and about 480 minutes, preferably between about 60 minutes and about 360 minutes, still preferably between about 120 minutes and about 300 minutes. It has to be noted that the higher the temperature, the lower the duration need to be.

In a particularly preferred embodiment, the method for producing a green color comprises a heating at a temperature of between about 70° C. and 80° C. for between about 200 minutes and about 280 minutes.

The present technology also relates to the green color obtained by this method. Said green color is thus also called green phycocyanins and said green phycocyanins has a hue angle between about 120° and 190°.

In another embodiment, the present technology relates to a method for stabilizing a green color obtained from phycocyanins by the method described above comprising the step of mixing said color with at least one chelator selected from the group of ethylene diamine tetra acetic acid and/or its Na, K, Ca salts (EDTA), L-glutamic acid N,N-diacetic acid tetrasodium salt (GLDA), sodium hexametaphosphate, glutathione, metallothionein, 2,3-dimercapto-1-propanesulfonic acid, chlorella, garlic, cilantro, selenium, milk thistle, vitamin C, vitamin E, citrates, grape seed extract, quercetin, and lipoic acid, preferably from vitamin C and/or EDTA.

It has to be noted that, in the art, the skilled person is aware that vitamin C is a compound that may destabilize phycocyanins. Thus, it is particularly surprising that in the present technology the inventors use vitamin C as stabilization agent.

Preferably, the method for stabilizing a green color obtained from phycocyanins by the method described above further comprises a step of adding a least one sulphated polysaccharide, said sulphated polysaccharide being as described above.

The present technology relates to a stabilized green color obtained from phycocyanins by the method as described above.

Preferably, the obtained stabilized green color is stable under heat and/or light exposure.

In a certain embodiment, the green color according to the technology, stabilized or not, can be either in solid, pasty, or liquid form.

The present technology also relates to a product comprising the green color obtained from phycocyanins by the method of production described above or the stabilized green color obtained from phycocyanins by the method of stabilization described above.

In some embodiments, the acidic composition, the food product and/or the concentrated liquid according to the technology comprise or consist in phycocyanins under green color form.

According to a preferred embodiment, said green color has been submitted to pasteurization, such as flash pasteurization.

According to another aspect, the present technology relates to a method for improving the heat stability and/or the light stability of phycocyanins, comprising the steps of: a) adding and dissolving at least one sulphated polysaccharide in water, b) adding phycocyanins and mixing until dissolved at a pH of at least 5.0, preferably at a pH between 5.0 and 10.0.

For this method, in some embodiments, the compositions of the present technology comprise one or more sulphated polysaccharides as described above.

For this method, the phycocyanins are preferably acidic-pH-resistant phycocyanins having amino acid sequences, structure and functional properties as the ones described above.

For this method, the phycocyanins can be green phycocyanins according to the technology.

It was surprisingly observed that at higher concentrations, a shift to green occurs. Thus, the present invention relates to a composition comprising at least 0.1% of phycocyanins, such as at least 0.2%, at least 0.3%, at least 0.5%, at least 0.6%, at least 1%, at least 5%, at least 10%, preferably between about 0.1% and about 10% of phycocyanins, still preferably between about 0.1% and about 1% of phycocyanins. In a preferred embodiment, the phycocyanin is (a galdieria phycocyanin). said composition may have basic, neutral or acidic pHs.

Preferably, said composition is an acidic composition, i.e., a composition with a pH lower than 4.0, preferably between 2.0 and 4.0.

It is noted that the technology relates to all possible combinations of features described herein, preferred in particular are those combinations of features that are present in the claims. It will therefore be appreciated that all combinations of features relating to the composition according to the technology, all combinations of features relating to the process according to the technology and all combinations of features relating to the composition according to the technology and features relating to the process according to the technology are described herein.

One of the advantages of the present technology resides, as can be seen in the following examples, in the fact that the colouring provided by the acidic-pH-resistant phycocyanin is more stable over time.

Other aspects and features of the present technology will become apparent from reading the examples and figures.

### EXAMPLES

### Example 1: Production of Phycocyanins from Galdieria sulphuraria

Strain: Galdieria sulphuraria (also called Cyanidium caldarium) UTEX #2919. Batch culture medium: 30 g/L glycerol, 8 g/L (NH₄)₂SO₄, 1 g/L KH₂PO₄, 716 mg/L MgSO₄, 44 mg/L CaCl₂), 3 mL/L of Fe-EDTA stock solution (6.9 g/L FeSO₄ and 9.3 g/L EDTA-Na₂) and 4 mL/L of trace metal solution (3.09 g/L EDTA-Na₂; 0.080 g/L CuSO₄, 5H₂O; 2.860 g/L H₃BO₃; 1.820 g/L MnCl₂; 0.220 g/L ZnSO₄, 7H₂O.

Culture conditions: The cultures are carried out in 1 m³ useful-volume reactors with computer-controlled automated systems in Fed-batch mode as described in the patent WO 2020161280, incorporated by reference herein. For the feed medium, the quantity of carbon source is adjusted according to the dry mass targeted at of the culture. All the other elements of the medium are added while respecting the proportions used for the batch medium defined in the example. Culture pH is regulated by adding base (14% ammonia solution (wNH₃/w)) and/or acid (4N sulphuric acid solution). Culture temperature is set to 37° C. Tracking of cell growth is carried out at different times by measuring absorbance at 800 nm and a measurement of the dry mass is carried out by filtration. The performance characteristics of the culture at the end of growth are summarized in the following Table 1.

TABLE 1
Performance characteristics of the Fed-batch culture

| | |
|---|---|
| Time (h) | 160 |
| Dry biomass (g/L) | 80 |
| Intracellular C-phycocyanins | 80 |
| content (mg/g dry biomass) | |

Measurements of intracellular phycocyanins content per gram of dry matter were carried out using the extraction by Modeste and colleagues, Toxicology Research and Applications VOL. 3, 1-13, 2019 and measured with the method described by Yoshikawa and Beal, JOURNAL OF AOAC INTERNATIONAL VOL. 91, NO. 3, 2008] while replacing the phosphate buffer with Tris-Cl buffer.

### Example 2: Extraction of Phycocyanins

Strains Galdieria sulphuraria (UTEX #2919) and/or Cyanidioschyzon merolae (ACUF199) were cultivated under the conditions of Example 1. Phycocyanins was then extracted according the protocol described in WO 2020/161280 and WO 2018/17833, both of which are incorporated herein by reference. An extract (also called “phycocyanins extract” or “crude extract”) which comprises, in addition to the phycocyanins of interest, other water-soluble proteins, was obtained. The phycocyanins extract can have several possible qualities depending on the method of extraction and/or purification used. For example, a crude extract will contain a higher amount of water-soluble proteins, other than phycocyanin, than that found in a purified extract. Purity index is traditionally expressed by calculating the ratio of the absorbance of the solution at 618 nm (specific absorbance of phycocyanin) to that at 280 nm, the specific absorbance of aromatic amino acids giving an idea of the total protein level. The lower this ratio, the higher the amount of proteins other than phycocyanin in the solution. The crude extract was purified using the KrosFlo® tangential flow filtration system from Spectrum® Labs. Table 2 indicates the purity index measurement of a phycocyanins extract before and after purification.

TABLE 2
Purity index measurement of a phycocyanin
extract before and after purification.

| | Purity index |
|---|---|
| | (Abs 618 nm/Abs 280 nm) |
| Crude phycocyanin extract | 1.5 |
| Purified extract | 3.2 |

### Example 3: Stability of Phycocyanins Over 4 hours in a Beverage

Purified phycocyanins extract from Galdieria as outlined in Examples 1 and 2 was used to perform stability test (4 hours at 43° C.) beverage model (water, 7% sucrose, citric acid pH 3) in which different concentration of the Galdieria extract (Galdieria extract containing about 25% phycocyanins) was added in amounts of 0.4% (i.e., 0.10% phycocyanin), 0.2% (i.e., 0.05% phycocyanin), and 0.1% (i.e., 0.025% phycocyanin) of the total weight of the beverage.

Stability was evaluated measuring the color differences using dE CMC value between negative control (kept at 4° C.) and 43° C. treated samples. Model beverages were prepared at 3 different Galdieria extract concentrations: 0.1%, 0.2%, and 0.4%, i.e. 0.03 wt %, 0.06 wt % and 0.10 wt % of phycocyanins, together with 7 wt % granulated sugar and adjusted to pH 3.0 with 50% citric acid solution. The samples were placed in a 43° C. oven for 4 hours and measured on colorimeter to obtain a dE CMC value. When dE CMC is above 2, color difference is detectable by the human eye.

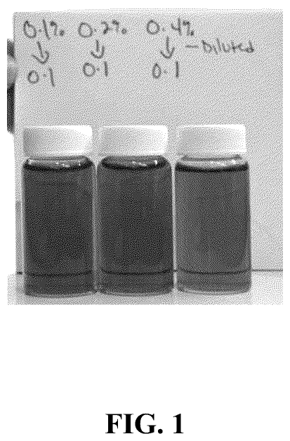

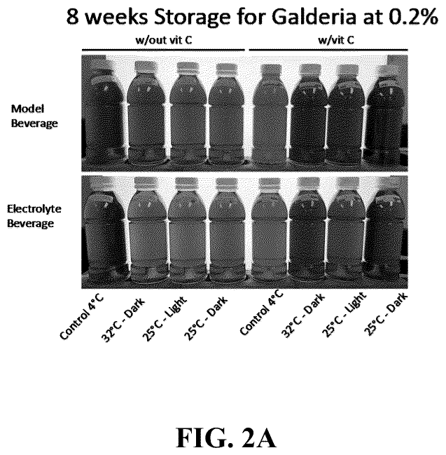

Results of this experiment are presented in FIG. 1, shows all three concentrations diluted to 0.10% after heat treatment for visual comparison. Beverage on far left is 0.1% w/w Galdieria extract and had an average dE CMC of 1.9 after heat treatment. The middle beverage is 0.2% w/w Galdieria extract and had an average dE CMC of 5.475 after heat treatment. Beverage on far right is 0.4% w/w Galdieria extract and had an average dE CMC of 16.45 after heat treatment. These results indicate that the more phycocyanin is present in the composition, the less stable is the product and/or the colouring.

### Example 4: Stability of Phycocyanins Over 8 Weeks in a First Series of Beverages

Model beverages were tested for 8 weeks stability. The model beverages were formulated as presented in Table 3. Table 4 shows the content in electrolytes for the indicated model beverages and Table 5 shows the electrolyte blend formulation for the indicates model beverages. Galdieria extract contains about 30% phycocyanins.

TABLE 3
Model Beverage formulations

| | % (w/w) Without | % (w/w) With |
|---|---|---|
| Ingredient | Vitamin C | Vitamin C |
| Water | 87.74 | 87.71 |
| Sugar | 12 | 12 |
| Galdieria extract | 0.2 | 0.2 |
| Phycocyanins | 0.06 | 0.06 |
| Vitamin C | 0 | 0.03 |
| Citric Acid* | 0.06 | 0.06 |

*Adjusted to pH 3.0

TABLE 4
Electrolyte beverage formulations.

| | % (w/w) Without | % (w/w) With |
|---|---|---|
| Ingredient | Vitamin C | Vitamin C |
| Water | 87.57 | 87.54 |
| Sugar | 12 | 12 |
| Galdieria extract | 0.2 | 0.2 |
| Phycocyanins | 0.06 | 0.06 |
| Vitamin C | 0 | 0.03 |
| Citric Acid* | 0.06 | 0.06 |
| Electrolyte | 0.17 | 0.17 |
| Blend | | |

TABLE 5
Electrolyte Blend Formulation

| | % (w/w) Without |
|---|---|
| Ingredient | Vitamin C |
| Sodium Chloride | 72.89 |
| Potassium Phosphate | 27.11 |

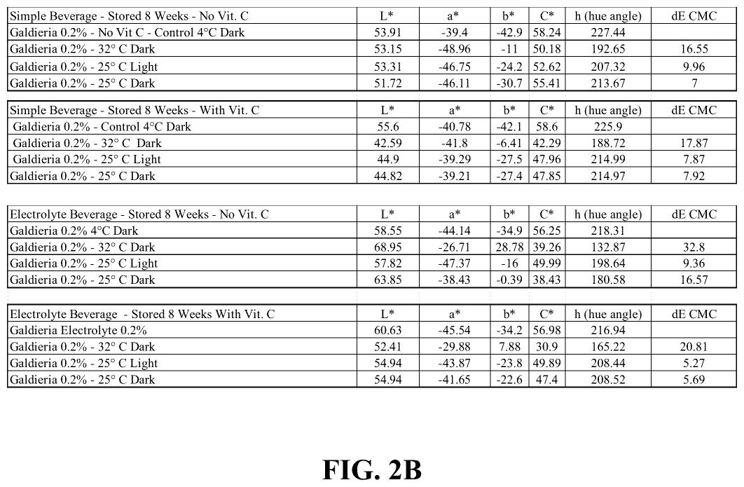

Referenced beverages were pasteurized using HTST pasteurization (BottomLine Pasteurizer, Advantage Engineering) for 30 seconds at 75° C. followed by cooling in an ice bath. After cooling, beverages were stored at various temperatures including 4° C. (this served as the control), 32° C. in the dark, 25° C. in the dark and light. The beverages were removed for observations and photographs at 8 weeks. FIGS. 2A and 2B shows the results of the stability test on model and electrolyte beverage with 0.2% Galdieria extract. Notable Changes During Beverage Storage Galdieria at 0.2%. A decrease in the hue angle during storage indicates a shift in hue from blue to green thus it can be noted that blue shows nuances of green as storage time increases and that higher storage temperatures result in greater shift towards green.

### Example 5: Stability of Phycocyanins Over 8 Weeks in a Second Series of Beverages

Model beverages were tested for 8 weeks stability. The model beverages were formulated as presented in Table 6. Table 7 shows the electrolyte blend formulation for the indicates model beverages. Galdieria extract contains about 30% phycocyanins.

TABLE 6
Electrolyte beverage formulation.

| | % (w/w) Without | % (w/w) With | % (w/w) Without | % (w/w) With |
|---|---|---|---|---|
| Ingredient | Vitamin C | Vitamin C | Vitamin C | Vitamin C |
| Water | 87.57 | 87.54 | 87.37 | 87.34 |
| Sugar | 12 | 12 | 12 | 12 |
| Galdieria | 0.2 | 0.2 | 0.4 | 0.4 |
| extract | | | | |
| Phycocyanins | 0.006 | 0.006 | 0.012 | 0.012 |
| Vitamin C | 0 | 0.03 | 0 | 0.03 |
| Citric Acid* | 0.06 | 0.06 | 0.06 | 0.06 |
| Electrolyte | 0.17 | 0.17 | 0.17 | 0.17 |
| Blend | | | | |

*Adjusted to pH 3.0

TABLE 7
Electrolyte Blend Formulation

| | % (w/w) Without |
|---|---|
| Ingredient | Vitamin C |
| Sodium Chloride | 72.89 |
| Potassium Phosphate | 27.11 |

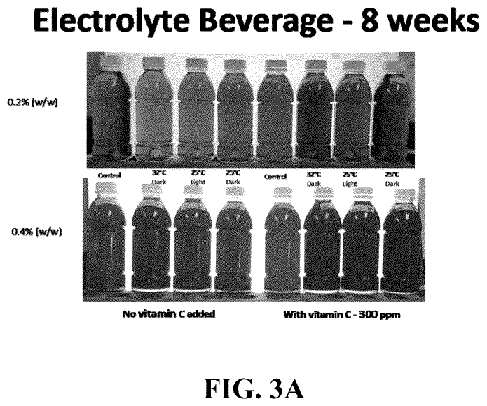

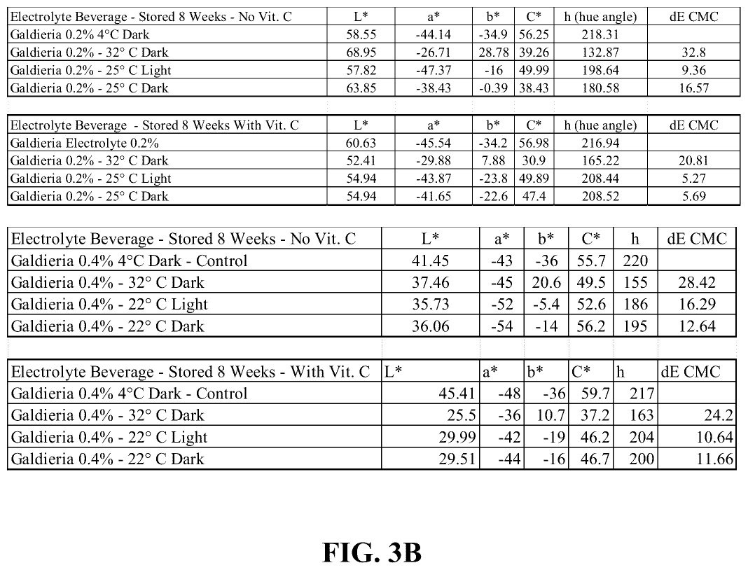

FIGS. 3A and 3B shows the results of the stability test on model beverages with 0.2% and 0.4% Galdieria extract. The addition of vitamin C causes darkening (decrease in L* value) relative to no vitamin C addition. Apparent hue difference between those with vitamin C and those without vitamin C is likely due to the darkening effect. The addition of vitamin C shows a slight protective effect on hue based on Galdieria 's phycocyanins.

### Example 6: Stability of Phycocyanins Over 4 Weeks in a Beverage in Absence of Vitamin C

Stability of phycocyanins in beverages in absence of Vitamin C was assessed. The model beverages were formulated as presented in Table 8. Previous Table 7 shows the electrolyte blend formulation for the indicates model beverages. Galdieria extract contains about 30% phycocyanins.

TABLE 8
Model beverage formulation without vitamin C

| | % (w/w) Without | % (w/w) Without |
|---|---|---|
| Ingredient | Vitamin C | Vitamin C |
| Water | 87.93 | 87.92 |
| Sugar | 12 | 12 |
| Galdieria extract | 0.01 | 0.02 |
| Phycocyanins | 0.003 | 0.006 |
| Citric Acid* | 0.06 | 0.06 |

*Adjusted to pH 3.0

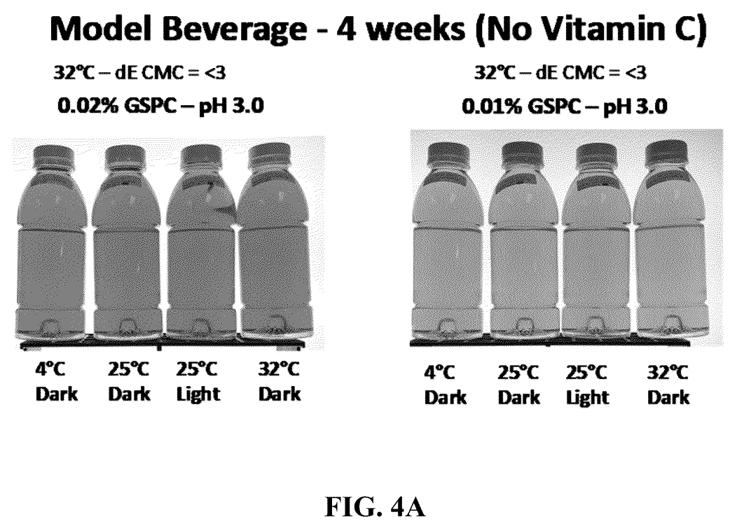

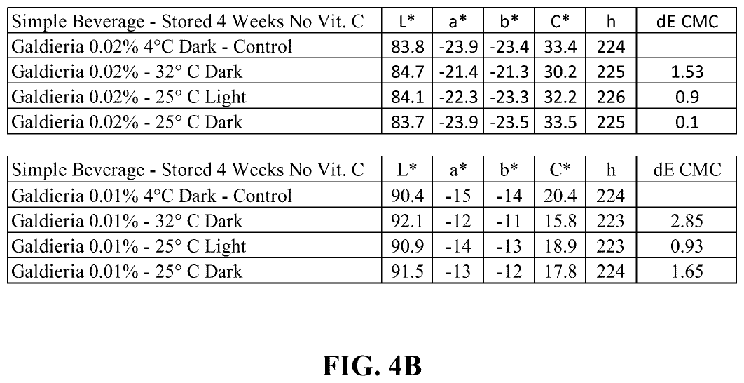

Referenced beverages were pasteurized using HTST pasteurization (BottomLine Pasteurizer, Advantage Engineering) for 30 seconds at 75° C. followed by cooling in an ice bath. After cooling, beverages were stored at various temperatures including 4° C. (this served as the control), 32° C. in the dark, 25° C. in the dark and light. The beverages were removed for observations and photographs at 4 weeks. FIGS. 4A and 4B shows the results of a stability test on model beverage with 0.01% and 0.02% Galdieria extract. The hue angle remains nearly constant for all storage conditions after 4 weeks for 0.02% and 0.01% Galdieria in other words when Galdieria was used at concentration of 0.01% and 0.02%, no significant change in colour of the beverage was observed. With dE CMC value<3 color changes were barely visible. Mechanism that generates instability are not really known but are associated with acid pH. The more acidic the pH is, the more unstable phycocyanin is.

### Example 7: Stability of Galdieria Extract in Combination with Lambda Carrageenan

The effect of Lambda carrageenan on the stability of Galdieria extract in model beverages was assessed. Model beverages (Control) were made by dissolving granulated sugar 12 wt % into deionized water, and 0.05% of Galdieria extract powder (Galdieria extract contains about 30% phycocyanins), that is to say 0.015% of phycocyanin, relative to the total weight of the beverage or 0.01% of Galdieria extract powder, that is to say 0.003% of phycocyanin, relative to the total weight of the beverage. Lambda carrageenan powder was added to the model beverage at differing concentrations for obtaining a ratio phycocyanins:carrageenans of 1.5:1. The pH of the beverage was then adjusted to 3 using 50% citric acid. The preparations were tested for colour change through flash pasteurization. The model beverage and carrageenan containing beverages were placed into 20 ml scintillation vials and then immersed into an 80° C. water bath for 4 minutes. The vials where then immediately immersed in ice water before measuring the contents on a colorimeter. Each beverage vial was placed in a 80° C. bath for 4 minutes and then ice bath for 4 minutes to simulate HTST pasteurization. The dE CMC was then measured to determine color loss. If dE CMC is >2, it is within visible range. The presence of Lambda carrageenan in acidic beverages yielded better heat stability and a hue similar to Blue 1.

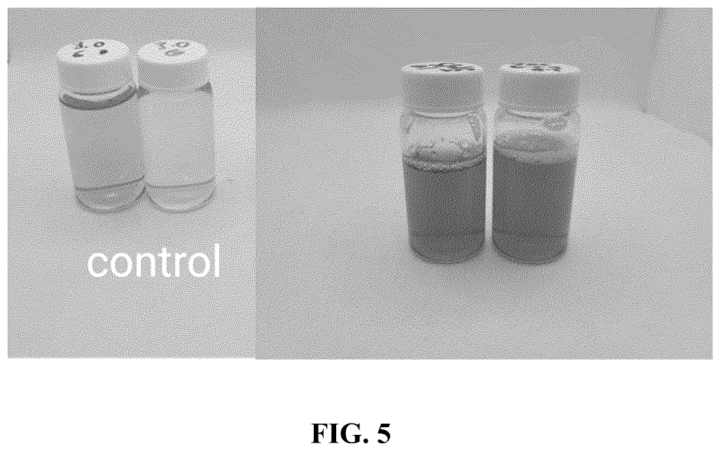

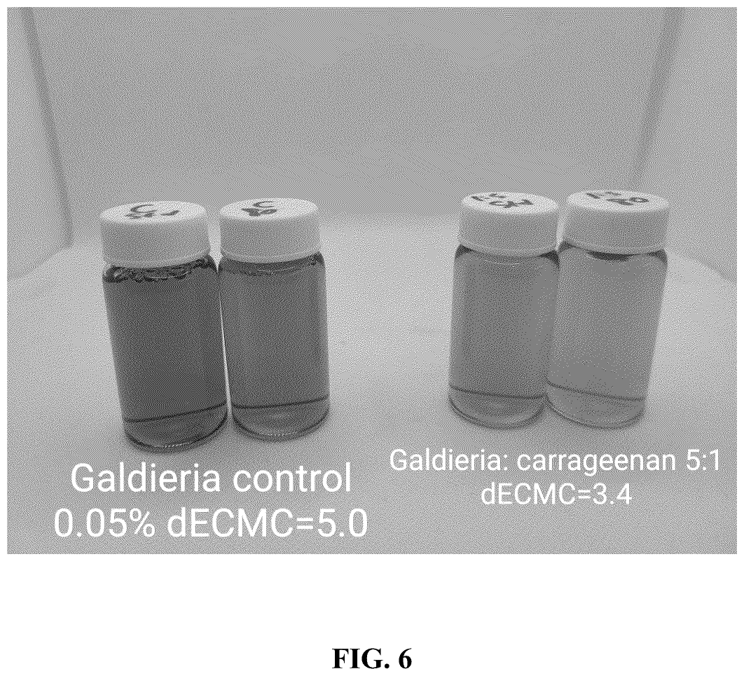

FIG. 5 and FIG. 6 display the resulting colour loss due to flash pasteurization. Each picture has the unheated vial on the left and the heated vial on the right. Greater colour loss can be seen on the control picture (left) than in the Galdieria's phycocyanins:Carrageenan picture (right). This confirms that the Lambda carrageenan assists in stabilizing Galdieria and in preserving colour in heated conditions. Galdieria 0.05% model beverage control (left) has a dE CMC of 5.0 after HTST pasteurization whereas a Galdieria:Carrageenan showing 1.5:1 ratio (0.0015% Galdieria's phycocyanins:0.01% carrageenan) (right) has a dE CMC of 3.4 after HTST pasteurization. These results indicate that a higher concentration of Galdieria makes for a less stable product and also that Lambda carrageenan has a protective effect on the phycocyanins during heat treatment.

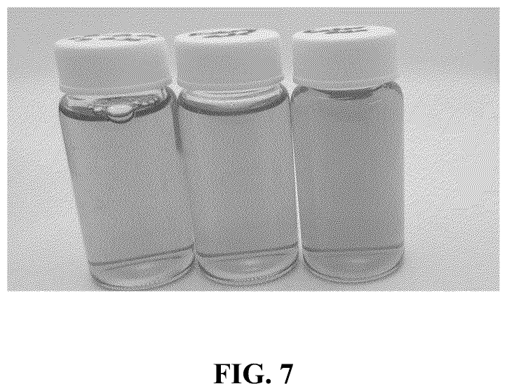

FIG. 7 shows the comparison of Galdieria's phycocyanins:carrageenans (1.5:1) containing beverages to commercially available beverages Gatorade® and Powerade® (dE CMC 1.99). Vial on left shows Galdieria's phycocyanins:carrageenans model beverage at a 1.5:1 ratio (0.05% Galdieria extract, 0.025% carrageenans) compared to vial in middle containing blue Powerade and vial on right containing blue Gatorade. The measured dE CMC between the Galdieria beverage and the Powerade and Gatorade beverages is 1.99. This is within visible range. This low deCMC value indicates a color match of the Galdieria's phycocyanins:carrageenan (1.5:1) beverage to blue 1 containing beverages.

### Example 8: Stability of Different Ratio of Phycocyanins:Carrageenans Upon Flash Pasteurization

Model beverages (Control) were made by dissolving granulated sugar 12 wt % into deionized water and different concentrations of extracts powder and adjusting pH to 3.0 with 50% citric acid solution. Test beverages prepared by adding Lambda carrageenan powder to the model beverages at differing concentrations, and then further adjusting the beverage to a pH of 3.0 using 50% citric acid. The concentrations of phycocyanins and carrageenans applied are presented in Table 9 hereafter.

TABLE 9
Concentrations of phycocyanins and carrageenans

| | | | Concentration | |
|---|---|---|---|---|
| | Concentration | Concentration | of lambda- | |
| Origin of the | of extract | of phycocyanins | carrageenans | Ratio |
| extract | (% by weight) | (% by weight) | (% by weight) | phycocyanins:carrageenans |
| Galdieria | 0.05 | 0.015 | 0 | N/A |
| | | 0.015 | 0.01 | 1.5:1 |
| | | 0.015 | 0.025 | 0.6:1 |
| | | 0.015 | 0.05 | 0.3:1 |
| | | 0.015 | 0.0025 | 6:1 |
| | | 0.015 | 0.005 | 3:1 |
| | 0.10 | 0.030 | 0 | N/A |
| | | 0.030 | 0.05 | 0.6:1 |
| | 0.25 | 0.075 | 0 | N/A |
| | | 0.075 | 0.025 | 3:1 |
| | | 0.075 | 0.05 | 1.5:1 |
| Spirulina | 0.05 | 0.015 | 0.05 | 0.3:1 |
| | 0.1 | 0.03 | 0.05 | 0.6:1 |

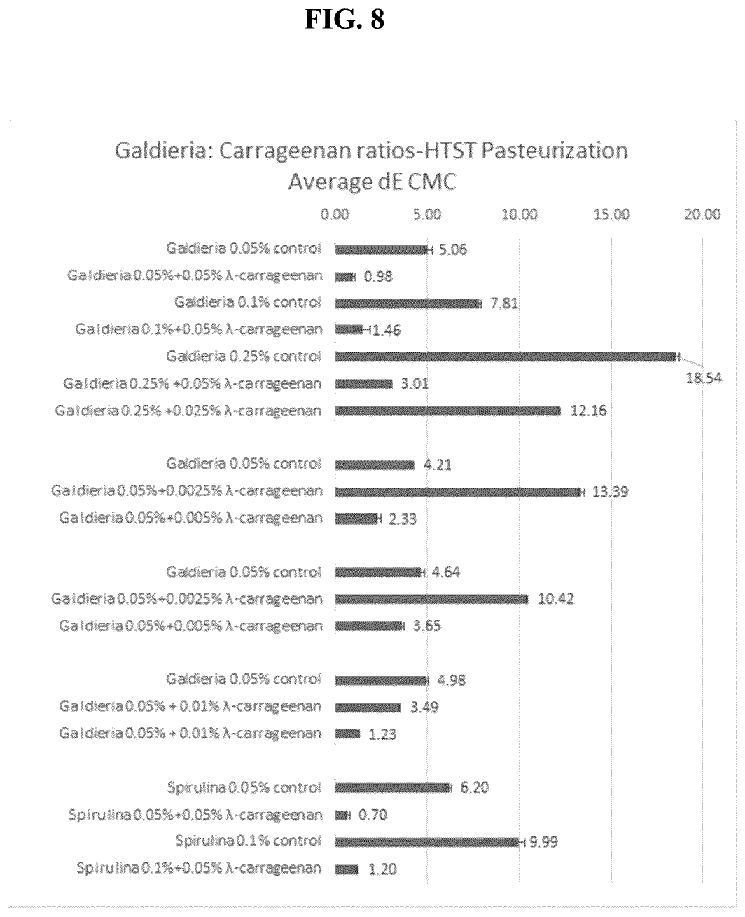

The preparations were tested for color change through flash pasteurization. The model beverage and carrageenans containing beverages were placed into 20 ml scintillation vials and then immersed into an 80° C. water bath for 4 minutes. The vials where then immediately immersed in ice water before measuring the contents on a colorimeter. FIG. 8 shows HTST pasteurization of beverages at differing ratios of Galdieria phycocyanins:lambda carrageenan. The dE CMC values<2 are at ratios 0.3:1, and 0.6:1, indicating that the ideal ratios of Galdieria:lambda carrageenan to be between about 0.6:1 and about 0.3:1.

### Example 9: Stability of Galdieria Extract in Combination with Lambda Carrageenan Upon Flash Pasteurization

Model beverages (control) containing no carrageenan were prepared by dissolving granulated sugar into deionized water and adding Galdieria powder at a 0.05% concentration, i.e. 0.015% of phycocyanin related to the total weight of the composition, and adjusting the pH of the composition to 3.0 with 50% citric acid solution. Test beverages were made by blending the Galdieria powder and lambda carrageenan in a 5:1 ratio and dissolving granulated sugar to achieve 12 wt % into deionized water. The pH was then adjusted to 3.0 using 50% citric acid. The preparations were tested for color change through flash pasteurization. The model beverage and carrageenan containing beverages were placed into 20 ml scintillation vials and then immersed into an 80° C. water bath for 4 minutes. The vials where then immediately immersed in ice water before measuring the contents on a colorimeter. Table 10 provides the dE CMC results. The results show that the model beverage carrageenan had a protective effect on color during heat treatment. The model beverage without carrageenan has an average dE CMC of 4.37, which is outside the visible range, as seen in the photo on the left, while the beverage containing carrageenan has an average dE CMC of 1.225, indicating it is within visible range, as seen in the photo on the left. This further proves the protective effect of lambda carrageenan in phycocyanin beverages under heat treatment.

TABLE 10
dE CMC of tested beverages

| | dE | dE | Average |
|---|---|---|---|
| | CMC 1 | CMC 2 | dE CMC |
| Galdieria extract | 4.4 | 4.34 | 4.37 |
| 0.05% control | | | |
| Galdieria extract | 1.24 | 1.21 | 1.225 |
| 0.05% + Lambda- | | | |
| carrageenan 0.01% | | | |

### Example 10: Preparation of a Green Concentrate for Use in Beverages

A green concentrate was prepared for use in beverages comprising Galdieria extract. The beverages were prepared as follows: 1% by weight Galdieria extract (powder form, 0.30% by weight of phycocyanin) related to the total weight of the beverages) dissolved in DI water and adjusted to pH 3.0 with 50% citric acid, placed in a 75° C. bath for 4 hours to achieve a green liquid. This green liquid was then added to model beverage system at 2.5% concentration with 12% sugar.

Experiment: testing stability of green beverages in 43° C. oven for accelerated shelf-life stability. Green beverages were placed in 43° C. oven and tested after 3 and 4 days. Table 11 shows green beverages in accelerated shelf-life conditions. After 3 and 4 days in 43° C. oven, the green beverages were outside of visible range with dE CMCs of 3.22 and 4.07 respectively. In some instances, carrageenan could be added to the composition after the composition undergoes the green shift.

TABLE 11
Green beverages in accelerated shelf-life conditions

| Sample | L | a | b | dE CMC |
|---|---|---|---|---|
| Control model beverage | 95.79 | −6.98 | 9.61 | standard |
| (2.5% green) | | | | |
| 3 days in 43° C. oven | 94.70 | −5.12 | 5.98 | 3.22 |
| 4 days in 43° C. oven | 94.61 | −4.63 | 5.02 | 4.07 |

### Example 10Bis: Stability of Green Beverages Prepared with Galdieria Phycocyanins and Vitamin C

A green Galdieria concentrate is prepared as follow:
1. 1% of a Galdieria powder is diluted within deionized water;
2. the pH is adjusted with citric acid to 3.0;
3. the composition obtained in step 2. Is heated in 75° C. water bath for 4 hours.

Then several samples are prepared with the previously obtained green extract so as to contain:
12% by weight of crystalline sucrose; and,
0.1% and 0.2% by weight of green Galdieria concentrate or 0.02% by weight of powder Galdieria blue extract; and,
optionally 300 ppm of Vitamin C.

The hue obtained between the standard blue Galdieria and the green Galdieria extracts are shown in Table 12.

TABLE 12
Hue between standard blue Galdieria and green Galdieria extracts

| Sample | L* | a* | b* | h |
|---|---|---|---|---|
| Galdieria Blue powder | 87.34 | −18.82 | −20.71 | 227.74 |
| beverage 0.02% | | | | |
| Green Galdieria | 91.04 | −9.17 | 9.62 | 133.61 |
| beverage 0.1% | | | | |
| Green Galdieria | 82.75 | −16.06 | 18.65 | 130.73 |
| beverage 0.2% | | | | |
| Green Galdieria | 91.06 | −9.36 | 10.05 | 132.95 |
| beverage 0.1% w/Vit C | | | | |
| Green Galdieria | 83.12 | −16.22 | 19.21 | 130.18 |
| beverage 0.2% w/Vit C | | | | |

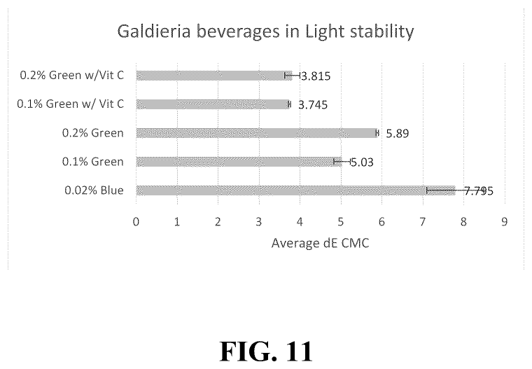

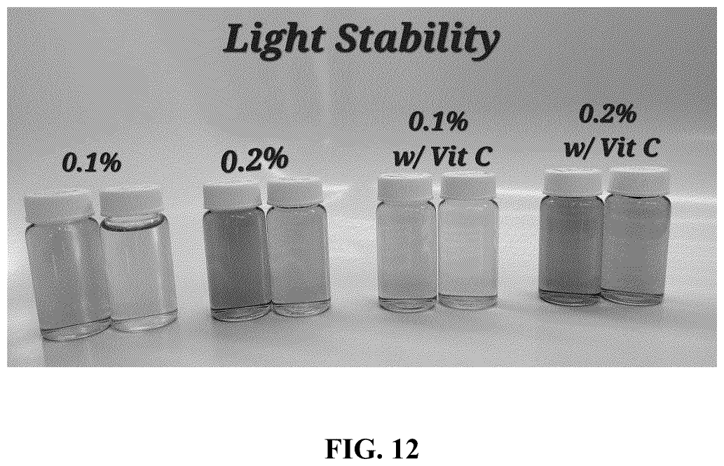

Each sample is tested for dE CMC on ColorQuest Colorimeter before and after a light treatment, 2 hours in Suntest XLS⁺. dE CMC for samples whose have undergone light treatment are presented in FIG. 11 and FIG. 12. The results show that vitamin C had a protective effect in light treatment.

### Example 10Ter: Stability of Green Beverages Prepared with Galdieria Phycocyanins

A green Galdieria concentrate is prepared as previously described in example 10bis. Then several samples are prepared with the previously obtained green extract so as to contain:
12% by weight of crystalline sucrose; and,
0.1% and 0.2% by weight of green Galdieria concentrate or 0.02% by weight of powder Galdieria blue extract. Each sample is tested for dE CMC on ColorQuest Colorimeter before and after the following treatments:
   HTST pasteurization (80° C., 5 minutes); Light treatment: 2 hours in Suntest XLS+; and, Accelerated heat stability (4 days, 40° C. oven).

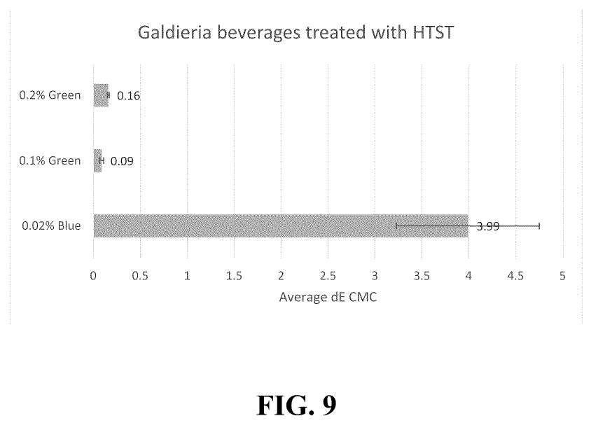

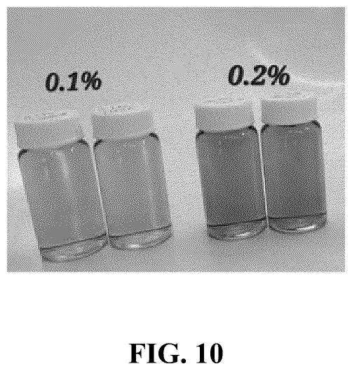

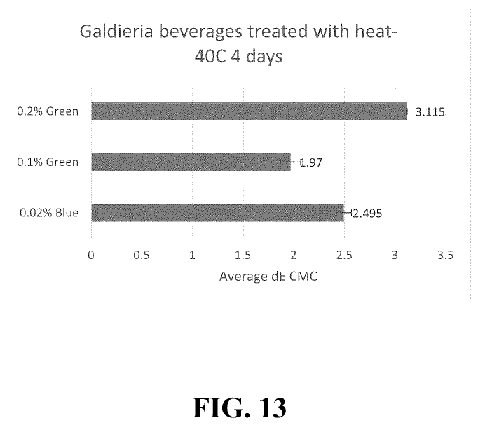

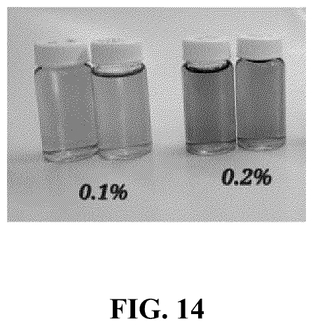

dE CMC for samples whose have undergone HTST are presented in FIG. 9 and FIG. 10. In view of these results, the green beverages are more stable in HTST than the blue one (control). dE CMC for samples whose have undergone light treatment are presented in FIG. 11 and FIG. 12. The results show the green beverages are more stable in light than the blue one (control). dE CMC for samples whose have undergone accelerated stability treatment are presented in FIG. 13 and FIG. 14. Lower concentration of green in a beverage system proves more stable than the blue control beverage. There is an inverse relationship between use rate and accelerated heat stability. In view of the above, green Galdieria concentrate beverages are stable under heat and light.

### Example 11: Stability of Different Phycocyanins Extracts in Combination with Lambda Carrageenan Under Different pH

Beverages were made with 12% sugar, and pH was adjusted with 50% citric acid solution. The color content was 0.06% of Galdieria and Spirulina extracts, i.e. 0.018% by weight of phycocyanins relative to the total weight of the beverage, and lambda-carrageenan was added at 0.01% and 0.06%. The “model” or “control” beverages do not have added carrageenan. The “as is” beverages are beverages prepared without adding citric acid. The respective concentrations of phycocyanin and carrageenans applied are presented in Table 13 hereafter.

TABLE 13
Concentrations of phycocyanin and carrageenans applied

| | | | Concentration | |
|---|---|---|---|---|
| | Concentration | Concentration | of lambda- | |
| Origin of | of extract | of phycocyanins | carrageenans | Ratio |
| the extract | (% by weight) | (% by weight) | (% by weight) | phycocyanins:carrageenans |
| Galdieria | 0.06 | 0.018 | 0 (control) | 0 |
| | | | 0.06 | 0.3:1 |
| | | | 0.01 | 1.8:1 |
| Spirulina | 0.06 | 0.018 | 0 (control) | 0 |
| | | | 0.06 | 0.3:1 |
| | | | 0.01 | 1.8:1 |

The preparations were tested for color change through HTST pasteurization. The model beverage and carrageenan containing beverages were placed into 20 ml scintillation vials and then immersed into an 80° C. water bath for 4 minutes.

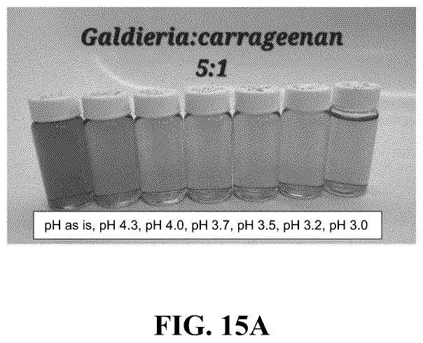

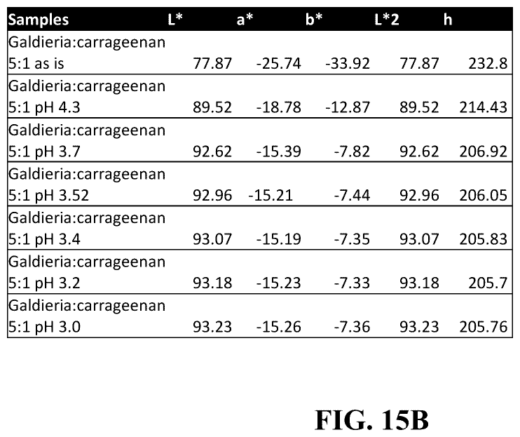

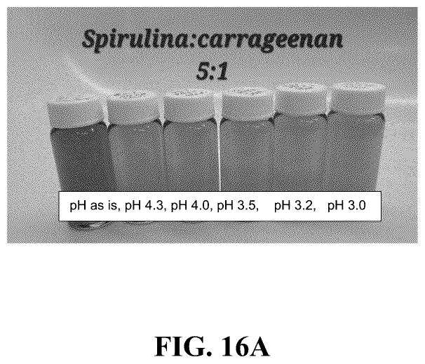

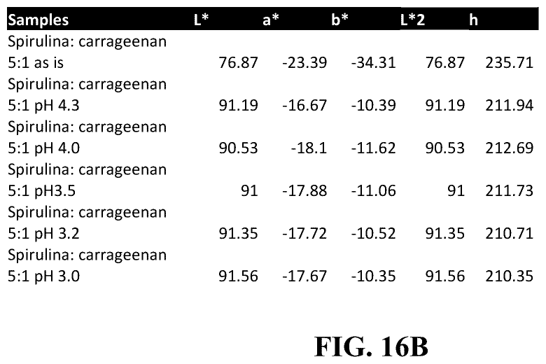

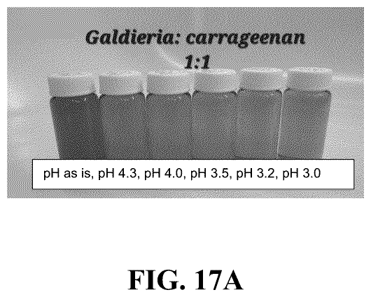

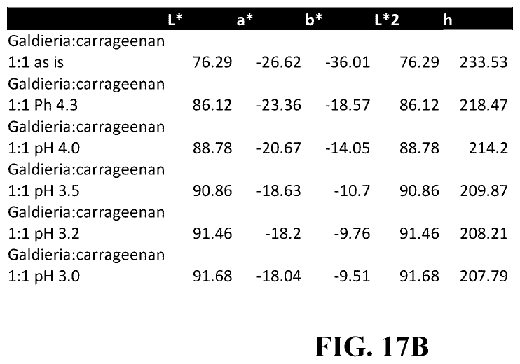

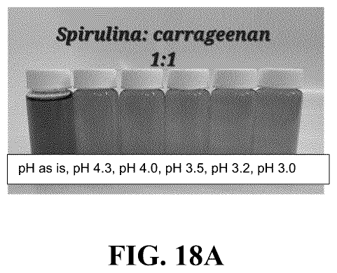

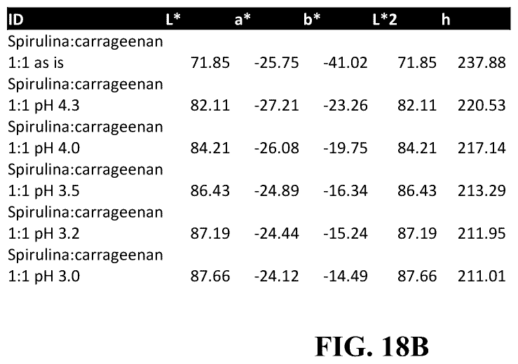

FIGS. 15A to 18B below show carrageenan beverages at various pH levels before heat treatment. While both Galdieria and Spirulina start to green in carrageenan system as pH is decreased, the color hue is different between the Galdieria and Spirulina carrageenan beverages, Galdieria has more yellow tones than that of Spirulina. Also prior to heat treatment, the Spirulina control beverages precipitated and were hazy below pH 3.5, whereas the Galdieria control was translucent and did not precipitate.

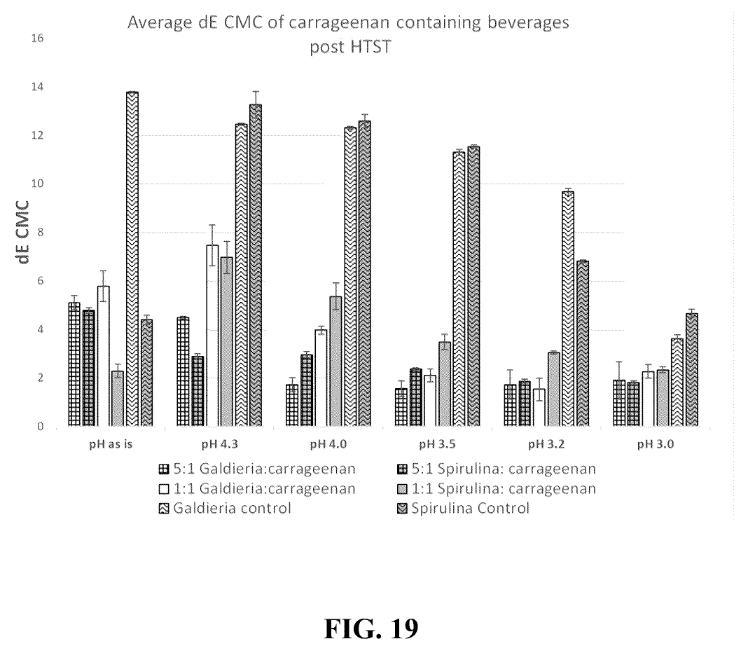

The dE CMC was measured on ColorQuest Colorimeter and reported in FIG. 19. These results show that the beverages containing carrageenan are more heat stable than the control beverages which do not contain carrageenan. However, the Spirulina and Galdieria beverages behave differently in presence of carrageenan at the various start pH levels. For example, at pH 3.2, the 0.3:1 Galdieria beverages were more stable than the Spirulina beverages, and the opposite is true at pH 4.3 an the “as is” sample.

These results show that the beverages containing both Galdieria extract and carrageenan are more heat stable than beverages containing both Spirulina extract and carrageenan.

Further, it can be concluded that acidic compositions with phycocyanin from Galdieria and carrageenan are even more stable under heat treatment than the one with phycocyanin from spirulina when the pH is higher than 3.0 and lower or equal to 4.0.

### Example 12: Stability of Different Ratio of Phycocyanins:Carrageenans Upon Flash Pasteurization

Beverages were made with 12% sugar, and pH was adjusted to 3.0 and 4.0 with 50% citric acid solution. The color content was 0.06% of Galdieria and Spirulina extracts, i.e. 0.018% by weight of phycocyanin relative to the total weight of the beverage, and lambda-carrageenan was added at 0.01% and 0.06%. The respective concentrations of phycocyanin and carrageenans applied are the same as previously presented Table 13. The “model” or “control” beverages do not have added carrageenan.

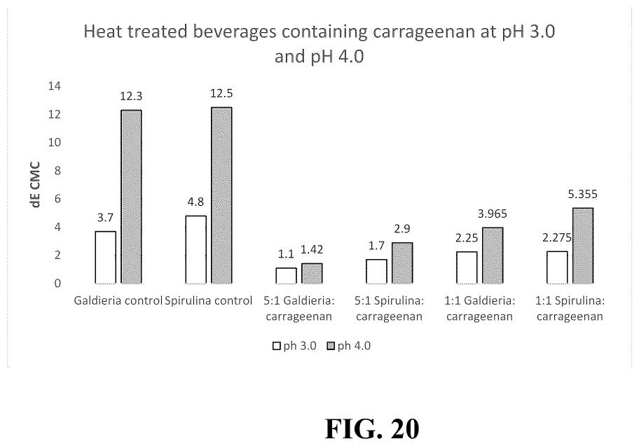

The preparations were tested for color change through HTST pasteurization. The model beverage and carrageenan containing beverages were placed into 20 ml scintillation vials and then immersed into an 80° C. water bath for 4 minutes. Before heat treatment, the color hue is different between the Galdieria and Spirulina based beverages including carrageenan. The Galdieria ones have more yellow tones than that of Spirulina. The dE CMC was measured on ColorQuest Colorimeter and reported in FIG. 20. FIG. 20 shows comparison of Galdieria and spirulina beverages with added carrageenan at pH 3.0 and 4.0. Results further prove that the spirulina-carrageenan containing beverage behaves differently at pH 4.0 than the Galdieria-carrageenan beverage at same pH. These results show that the beverages containing both Galdieria extract and carrageenan are more heat stable than the control beverages which do not contain carrageenan and than beverages containing both Spirulina extract and carrageenan. Further, it can be concluded that acidic compositions with phycocyanin from Galdieria and carrageenan are even more stable under heat treatment than the one with phycocyanin from spirulina when the pH is higher than 3.0 and lower or equal to 4.0.

### Sequences Information:

SEQ ID NO: 1: YP 009051179.1=1 mktpiteaia aadnqgrfls ntelqavngr yqraaaslea arsltsnaqr lingaaqavy 61 skfpytsqmp gpqyassavg kakcardigy ylrmvtyclv vggtgpmdey liagleeinr 121 tfdlspswyv ealnyvksnh glsgqaanea ntyidyaina ls
SEQ ID NO: 2: YP_009051180.1=1 mldafakvva qadargefls ntqldalskm vsegnkrldv vnritsnasa ivtnaaralf 61 seqpgliqpg gnaytnrrma aclrdmeiil ryvsyaiiag dssvlddrel nglretygal 121 gvpgasvavg vekmkdsaia iandpsgitt gdcsalmaev gtyfdraata vq
SEQ ID NO: 3: YP_009051103.1=1 msivtksivn adaearylsp geldriksfv lsgqrrlria qiltdnreri vkqagqqlfq 61 grpdivspgg naygeemtat clrdldyylr lvtygvvagd ispieeigly gvkemynslg 121 tpisavaegi kamknvacsl lsgddsaeag fyfdytigam q
SEQ ID NO: 4: YP 009051104.1=1 mqdaitavin tadvqgkyld nssieklkgy fqtgelrvra aatiaanaag iikdavaksl 61 lysditrpgg nmyttrryaa cirdldyylr yatysmlagd psildervln glketynslg 121 vpigatiqsi qamkevtssl vgseagkemg iyfdyicsgl s

All references cited in this specification, and their references, are incorporated by reference herein in their entirety where appropriate for teachings of additional or alternative details, features, and/or technical background.

While the disclosure has been particularly shown and described with reference to particular embodiments, it will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1-54. (canceled)

55. An acidic composition comprising phycocyanins, wherein the phycocyanins are present in the composition in an amount ranging from between about 0.001 wt % and about 0.1 wt %.

56. The acidic composition of claim 55, further comprising a chelating agent.

57. The acidic composition of claim 56, wherein the chelating agent is a synthetic or a natural compound.

58. The acidic composition of claim 57, wherein the chelating agent is selected from the group consisting of ethylene diamine tetra acetic acid and/or its Na, K, Ca salts (EDTA), L-glutamic acid N,N-diacetic acid tetrasodium salt (GLDA), sodium hexametaphosphate, glutathione, metallothionein, 2,3-dimercapto-1-propanesulfonic acid, chlorella, garlic, cilantro, selenium, milk thistle, vitamin C, vitamin E, citrates, grape seed extract, quercetin, lipoic acid and mixtures thereof.

59. The acidic composition of claim 58, wherein the chelating agent is vitamin C and/or EDTA.

60. The acidic composition of claim 55, wherein the phycocyanins are present in the composition in an amount selected from the group consisting of an amount ranging from between about 0.001 wt % and about 0.05 wt %, an amount ranging from between about 0.001 wt % and about 0.025 wt %, an amount ranging from between about 0.0025 wt % and about 0.010 wt %, and an amount ranging from between about 0.0025 wt % and about 0.005 wt %.

61. The acidic composition of claim 55, wherein the phycocyanins are a phycobiliprotein the apoprotein of which comprises the protein of SEQ ID NO: 1 or SEQ ID NO: 2, or variants thereof.

62. The acidic composition of claim 55, wherein the phycocyanins are extracted from an alga or a microalga of the genera Cyanidioschyzon, Cyanidium, or Galdieria.

63. The acidic composition of claim 55, wherein the phycocyanins are extracted from an alga or a microalga of the species selected from Cyanidioschyzon merolae 10D, Cyanidioschyzon merolae DBV201, Cyanidium caldarium, Cyanidium daedalum, Cyanidium maximum, Cyanidium partitum, Cyanidium rumpens, Galdieria daedala, Galdieria maxima, Galdieria partita, Galdieria phlegrea, Galdieria sulphuraria, preferentially the species Galdieria sulphuraria, Cyanidium caldarium, and Cyanidioschyzon merolae.

64. The acidic composition of claim 55, having a pH selected from the group consisting of a pH in the range of about 4 or less and a pH in the range of higher than about 3 and less than or equal to about 4.

65. The acidic composition of claim 55, further comprising an amount of at least one sulphated polysaccharide, wherein the at least one sulphated polysaccharide is carrageenan.

66. The acidic composition of claim 65, wherein the phycocyanins and at least one sulphated polysaccharide are present in the composition in a ratio selected from the group consisting of a ratio of between about 0.20:1 and about 20:1, a ratio between about 0.25:1 and about 10:1, a ratio between about 1:1 to about 10:1, and a ratio between about 0.3:1 and about 1.5:1.

67. The acidic composition of claim 55, characterized in that it is liquid or a solid.

68. A carbonated beverage comprising the acidic composition of claim 67.

69. A food product comprising the acidic composition of claim 55.

70. An acidic composition comprising phycocyanins and at least one sulphated polysaccharide, wherein the phycocyanins and at least one sulphated polysaccharide are present in the composition in a ratio selected from the group consisting of a ratio between about 0.20:1 and about 20:1, a ratio between about 0.25:1 and about 10:1, a ratio of between about 1:1 and about 10:1, and a ratio of between about 0.3:1 and about 1.5:1.

71. A food product comprising the acidic composition of claim 70.

72. An acidic composition comprising a Galdieria extract, wherein the Galdieria extract is present in the composition in an amount ranging from between about 0.004 wt % and about 0.4 wt % and a chelating agent.

73. The acidic composition of claim 72, wherein the chelating agent is a synthetic or a natural compound.

74. The acidic composition of claim 73, wherein the chelating agent is selected from the group consisting of ethylene diamine tetra acetic acid and/or its Na, K, Ca salts (EDTA), L-glutamic acid N,N-diacetic acid tetrasodium salt (GLDA), sodium hexametaphosphate, glutathione, metallothionein, 2,3-dimercapto-1-propanesulfonic acid, chlorella, garlic, cilantro, selenium, milk thistle, vitamin C, vitamin E, citrates, grape seed extract, quercetin, lipoic acid and mixtures thereof.

75. The acidic composition of claim 74, wherein the chelating agent is vitamin C and/or EDTA.

76. The acidic composition of claim 72, wherein the phycocyanins are a phycobiliprotein the apoprotein of which comprises the protein of SEQ ID NO: 1 or SEQ ID NO: 2, or variants thereof.

77. The acidic composition of claim 72, further comprising an amount of at least one sulphated polysaccharide.

78. The acidic composition of claim 55, wherein the composition is a concentrated liquid composition, and wherein the phycocyanins are present in the concentrated liquid composition in an amount ranging between about 50 mg/L and about 2500 mg/L or in an amount ranging between about 500 mg/L and about 1000 mg/L, the composition optionally further comprising at least one sulphated polysaccharide.

79. The acidic composition of claim 70, wherein the composition is a concentrated liquid composition, and wherein the phycocyanins are present in the concentrated liquid composition in an amount ranging between about 50 mg/L and about 2500 mg/L or in an amount ranging between about 500 mg/L and about 1000 mg/L, the composition optionally further comprising at least one sulphated polysaccharide.

80. The acidic composition of claim 72, wherein the composition is a concentrated liquid composition comprising phycocyanins, and wherein the phycocyanins are present in the concentrated liquid composition in an amount ranging between about 50 mg/L and about 2500 mg/L or in an amount ranging between about 500 mg/L and about 1000 mg/L, the composition optionally further comprising at least one sulphated polysaccharide.

81. A method for improving the heat stability and/or the light stability of phycocyanins, comprising one of the following:
1) adding and dissolving at least one sulphated polysaccharide in water and adding phycocyanins and mixing until dissolved at a pH of at least 5, or
2a) adding to a phycocyanin a chelating agent, wherein the phycocyanin is selected from an alga or a microalga of the genera Cyanidioschyzon, Cyanidium, or Galdieria and the chelating agent is selected from selected from the group consisting of ethylene diamine tetra acetic acid and/or its Na, K, Ca salts (EDTA), L-glutamic acid N,N-diacetic acid tetrasodium salt (GLDA), sodium hexametaphosphate, glutathione, metallothionein, 2,3-dimercapto-1-propanesulfonic acid, chlorella, garlic, cilantro, selenium, milk thistle, vitamin C, vitamin E, citrates, grape seed extract, quercetin, lipoic acid and mixtures thereof.
